(19) United States
(12) Patent Application Publication
(10) Pub. No.: US 2025/0269647 A1
(43) Pub. Date: Aug. 28, 2025

(54) HEAD CHIP, LIQUID JET HEAD, LIQUID JET RECORDING APPARATUS, AND METHOD OF MANUFACTURING HEAD CHIP

(71) Applicant: SII Printek Inc., Chiba-shi (JP)

(72) Inventors: Suguru MUNAKATA, Chiba-shi (JP); Tooru MINE, Chiba-shi (JP); Daichi NISHIKAWA, Chiba-shi (JP)

(21) Appl. No.: 19/049,882

(22) Filed: Feb. 10, 2025

(30) Foreign Application Priority Data
Feb. 26, 2024 (JP) 2024-026429

(51) Int. Cl. B41J 2/16; B41J 2/14

(52) U.S. Cl. CPC B41J 2/1634; B41J 2/14201; B41J 2002/14306; B41J 2202/22

(57) ABSTRACT

A head chip, a liquid jet head, a liquid jet recording apparatus, and a method of manufacturing a head chip each capable of preventing an occurrence of an unwanted processing residual due to laser processing are provided. The head chip according to an aspect of the present disclosure includes a flow channel member which includes a recess formed of a first laser irradiation trace, and in which a liquid circulates in the recess, and a bonded member which is bonded to the flow channel member so as to close the recess. The flow channel member is provided with a second laser irradiation trace extending along an opening edge of the recess.

### RELATED APPLICATIONS

This application claims priority to Japanese Patent application No. JP2024-026429, filed on Feb. 26, 2024, the entire content of which is incorporated herein by reference.

### BACKGROUND OF THE INVENTION

### 1. Field of the Invention

The present disclosure relates to a head chip, a liquid jet head, a liquid jet recording apparatus, and a method of manufacturing a head chip.

### 2. Description of the Related Art

A head chip to be installed in an inkjet printer may be provided with a flow channel member provided with a recess for ink to flow, and a bonded member which is bonded to the flow channel member so as to close the recess, in some cases. The recess is formed by, for example, laser processing (see, e.g., JP6-297180A (PTL1)).

In laser processing, a formation region of the recess out of a surface of the flow channel member is scanned with a laser beam. Thus, the recess due to the laser irradiation trace is formed in a scanning range with the laser beam.

However, when forming the recess with the laser processing, there is a possibility that a portion of the flow channel member melted with the laser irradiation flies to adhere to the vicinity of the opening edge of the recess as a foreign matter (hereinafter referred to as a “burr”). When an unwanted processing residual such as a burr protrudes from a surface of the flow channel member, there is a possibility that the unwanted processing residual is jammed between the flow channel member and the bonded member when bonding the bonded member to the surface of the flow channel member. When the unwanted processing residual is jammed, leakage of ink between the flow channel member and the bonded member, exfoliation of the bonded member, and so on are incurred.

The present disclosure provides a head chip, a liquid jet head, a liquid jet recording apparatus, and a method of manufacturing a head chip each capable of preventing an occurrence of the unwanted processing residual due to the laser processing.

### SUMMARY OF THE INVENTION

In order to solve the problems described above, the present disclosure adopts the following aspects.

(1) A head chip according to an aspect of the present disclosure includes a flow channel member which includes a recess formed of a first laser irradiation trace, and in which a liquid circulates in the recess, and a bonded member which is bonded to the flow channel member so as to close the recess, wherein the flow channel member is provided with a second laser irradiation trace extending along an opening edge of the recess.

According to the present aspect, since the second laser irradiation trace is formed along the opening edge of the recess, the unwanted processing residuals remaining on the opening edge of the recess after forming the first laser irradiation trace can be reduced. Thus, it is possible to prevent the unwanted processing residuals from being jammed when bonding the flow channel member and the bonded member to each other. As a result, the leakage of the liquid between the flow channel member and the bonded member is prevented, and at the same time, the bonding strength between the flow channel member and the bonded member can be ensured. Further, by reducing the unwanted processing residuals in the recess, it is possible to suppress the unevenness in the recess. Thus, it is possible to reduce the circulation resistance of the liquid which circulates in the recess to thereby smoothly circulate the liquid in the recess.

(2) In the head chip according to the aspect (1) described above, it is preferable that the recess includes a non-penetrating part configured to open only on a surface of the flow channel member, the surface facing to the bonded member side in a thickness direction, and a penetrating part which is configured to open on a bottom surface of the non-penetrating part, and penetrates the flow channel member in the thickness direction, and the second laser irradiation trace extends along at least an opening edge of the non-penetrating part.

According to the present aspect, there is a possibility that the unwanted processing residuals remaining on the opening edge of the non-penetrating part are exposed on the bonding surface of the flow channel member to the bonded member.

Therefore, by forming the second laser irradiation trace along at least the opening edge of the non-penetrating part, it is possible to prevent the unwanted processing residuals from being exposed on the bonding surface of the flow channel member to the bonded member.

(3) In the head chip according to one of the aspects (1) and (2) described above, it is preferable that the first laser irradiation trace extends in a first direction crossing a thickness direction of the flow channel member, and a plurality of first laser irradiation traces each identical to the first laser irradiation trace is formed in a second direction crossing the first direction when viewed from the thickness direction, and the second laser irradiation trace extends in the first direction along an outer side laser irradiation trace which is located at an outermost side in the second direction in the plurality of first laser irradiation traces.

According to the present aspect, by forming the second laser irradiation trace along the outer side laser irradiation trace out of the plurality of first laser irradiation traces, it is possible to effectively reduce the unwanted processing residuals remaining along the extending direction of the outer side laser irradiation trace.

(4) In the head chip according to the aspect (3) described above, it is preferable that a center in the second direction in the second laser irradiation trace is located at an inner side in the second direction from a center in the second direction in the outer side laser irradiation trace.

According to the present aspect, by disposing the center in the second direction in the second laser irradiation trace at an inner side from the center in the second direction in the outer side laser irradiation trace, it is possible to remove the unwanted processing residuals such as a burr due to an influence of the heat propagating to the periphery of the laser beam for forming the second laser irradiation trace. In this case, the influence of the heat propagating to the opening edge of the recess can be suppressed compared to when performing the scanning with the laser beam for forming the second laser irradiation trace on the same trajectory as the scan trajectory of the laser beam for forming the outer side laser irradiation trace. Thus, it is possible to prevent the unwanted processing residuals such as a wrinkle formed on the outer peripheral edge of the recess from being enlarged by the laser beam for forming the second laser irradiation trace. Therefore, it is possible to prevent the wrinkle and so on from being jammed as the unwanted processing residuals when bonding the flow channel member and the bonded member to each other. As a result, the leakage of the liquid between the flow channel member and the bonded member is prevented, and at the same time, the bonding strength between the flow channel member and the bonded member can be ensured.

(5) In the head chip according to any one of the aspects (1) through (4) described above, it is preferable that the recess is formed to have a rectangular shape having a longitudinal direction set to the first direction and a transverse direction set to the second direction when viewed from the thickness direction.

According to the present aspect, since the longitudinal direction of the recess and the extending direction of the second laser irradiation trace coincide with each other, the unwanted processing residuals can be reduced along the longitudinal direction of the recess.

(6) In the head chip according to any one of the aspects (1) through (5) described above, it is preferable that the recess includes a non-penetrating part configured to open only on a surface of the flow channel member, the surface facing to the bonded member side in a thickness direction, and a penetrating part which is configured to open on a bottom surface of the non-penetrating part, and penetrates the flow channel member in the thickness direction, and the penetrating part includes a first penetrating part, and a second penetrating part which is disposed at a distance in the first direction with respect to the first penetrating part, and is communicated with the first penetrating part through the non-penetrating part, a chip main body provided with a pressure chamber communicated with the recess through the first penetrating part and a circulation channel communicated with the recess through the second penetrating part is bonded to the flow channel member at an opposite side to the bonded member in the thickness direction, and the bonded member is provided with a jet hole configured to jet a liquid in the recess to an outside.

According to the present aspect, the flow channel member has a function as a return plate which is communicated with the jet hole, and circulates the liquid to a jet channel and a circulation channel. In this case, in the head chip according to the present disclosure, since the unevenness in the recess can be suppressed, the circulation of the liquid between the jet hole, the jet channel, and the circulation channel through the recess can smoothly be performed.

(7) A liquid jet head according to an aspect of the present disclosure preferably includes the head chip according to any one of the aspects (1) through (6) described above.

According to the present aspect, it is possible to provide a liquid jet head excellent in reliability.

(8) A liquid jet recording apparatus according to an aspect of the present disclosure includes the liquid jet head according to the aspect (7) described above.

According to the present aspect, it is possible to provide a liquid jet recording apparatus excellent in reliability.

(9) A method of manufacturing a head chip according to an aspect of the present disclosure is a method of manufacturing a head chip including a flow channel member provided with a recess through which a liquid circulates, and a bonded member which is bonded to the flow channel member so as to close the recess, the method including a first laser irradiation step of irradiating a bonding surface of the flow channel member to the bonded member with a first laser beam to thereby form an outer shape of the recess with a first laser irradiation trace, and a second laser irradiation step of irradiating the bonding surface with a second laser beam along an opening edge of the recess to thereby form a second laser irradiation trace along the opening edge of the recess.

According to an aspect of the present disclosure, it is possible to prevent the unwanted processing residuals due to the laser processing from occurring.

### BRIEF DESCRIPTION OF THE DRAWINGS

FIG. 1 is a schematic diagram of a printer according to a first embodiment.

FIG. 2 is a schematic configuration diagram of an inkjet head and an ink circulation mechanism related to the first embodiment.

FIG. 3 is an exploded perspective view of a head chip according to the first embodiment.

FIG. 4 is a cross-sectional view along the line IV-IV shown in FIG. 3.

FIG. 5 is a cross-sectional view along the line V-V shown in FIG. 3.

FIG. 6 is a cross-sectional view corresponding to the line VI-VI shown in FIG. 4.

FIG. 7 is an enlarged view of the VII portion shown in FIG. 4.

FIG. 8 is a cross-sectional view corresponding to the line VIII-VIII shown in FIG. 4.

FIG. 9 is a flowchart illustrating a method of manufacturing the head chip according to the first embodiment.

FIG. 10 is a process diagram illustrating the method of manufacturing the head chip according to the first embodiment.

FIG. 11 is a process diagram illustrating the method of manufacturing the head chip according to the first embodiment.

FIG. 12 is a process diagram illustrating the method of manufacturing the head chip according to the first embodiment.

FIG. 13 is a process diagram illustrating the method of manufacturing the head chip according to the first embodiment.

FIG. 14 is a process diagram illustrating the method of manufacturing the head chip according to the first embodiment.

FIG. 15 is a process diagram illustrating the method of manufacturing the head chip according to the first embodiment.

FIG. 16 is a process diagram illustrating the method of manufacturing the head chip according to the first embodiment.

FIG. 17 is a process diagram illustrating the method of manufacturing the head chip according to the first embodiment.

FIG. 18 is a process diagram illustrating the method of manufacturing the head chip according to the first embodiment.

FIG. 19 is a process diagram illustrating the method of manufacturing the head chip according to the first embodiment.

FIG. 20 is a process diagram illustrating the method of manufacturing the head chip according to the first embodiment.

FIG. 21 is a process diagram illustrating the method of manufacturing the head chip according to the first embodiment.

FIG. 22 is a process diagram illustrating the method of manufacturing the head chip according to the first embodiment.

FIG. 23 is a process diagram illustrating the method of manufacturing the head chip according to the first embodiment.

FIG. 24 is a process diagram illustrating the method of manufacturing the head chip according to the first embodiment.

FIG. 25 is a process diagram illustrating the method of manufacturing the head chip according to the first embodiment.

FIG. 26 is a process diagram illustrating the method of manufacturing the head chip according to the first embodiment.

FIG. 27 is a process diagram illustrating the method of manufacturing the head chip according to the first embodiment.

FIG. 28 is a process diagram illustrating the method of manufacturing the head chip according to the first embodiment.

FIG. 29 is a process diagram illustrating a method of manufacturing a head chip according to a second embodiment.

FIG. 30 is a process diagram illustrating the method of manufacturing the head chip according to the second embodiment.

FIG. 31 is a process diagram illustrating the method of manufacturing the head chip according to the second embodiment.

FIG. 32 is a process diagram illustrating the method of manufacturing the head chip according to the second embodiment.

FIG. 33 is a flowchart illustrating a method of manufacturing a head chip according to a third embodiment.

FIG. 34 is a process diagram illustrating the method of manufacturing the head chip according to the third embodiment.

FIG. 35 is a process diagram illustrating the method of manufacturing the head chip according to the third embodiment.

FIG. 36 is a process diagram illustrating the method of manufacturing the head chip according to the third embodiment.

FIG. 37 is a process diagram illustrating the method of manufacturing the head chip according to the third embodiment.

FIG. 38 is a process diagram illustrating the method of manufacturing the head chip according to the third embodiment.

FIG. 39 is a process diagram illustrating the method of manufacturing the head chip according to the third embodiment.

FIG. 40 is a process diagram illustrating the method of manufacturing the head chip according to the third embodiment.

FIG. 41 is a process diagram illustrating the method of manufacturing the head chip according to the third embodiment.

FIG. 42 is a process diagram illustrating the method of manufacturing the head chip according to the third embodiment.

FIG. 43 is a process diagram illustrating the method of manufacturing the head chip according to the third embodiment.

FIG. 44 is a process diagram illustrating the method of manufacturing the head chip according to the third embodiment.

FIG. 45 is a process diagram illustrating the method of manufacturing the head chip according to the third embodiment.

FIG. 46 is a process diagram illustrating the method of manufacturing the head chip according to the third embodiment.

FIG. 47 is a process diagram illustrating the method of manufacturing the head chip according to the third embodiment.

FIG. 48 is a process diagram illustrating the method of manufacturing the head chip according to the third embodiment.

FIG. 49 is a process diagram illustrating the method of manufacturing the head chip according to the third embodiment.

FIG. 50 is a process diagram illustrating the method of manufacturing the head chip according to the third embodiment.

FIG. 51 is a process diagram illustrating a method of manufacturing a head chip according to a fourth embodiment.

FIG. 52 is a process diagram illustrating the method of manufacturing the head chip according to the fourth embodiment.

FIG. 53 is a process diagram illustrating the method of manufacturing the head chip according to the fourth embodiment.

### DETAILED DESCRIPTION OF THE PREFERRED EMBODIMENTS

Some embodiments according to the present disclosure will hereinafter be described with reference to the drawings. In the embodiments and modified examples hereinafter described, constituents corresponding to each other will be denoted by the same reference symbols to omit the descriptions thereof in some cases. In the following descriptions, expressions representing relative or absolute arrangements such as “parallel,” “perpendicular,” “central,” and “coaxial” not only represent strictly such arrangements, but also represent the state of being relatively displaced with a tolerance, or an angle or a distance to the extent that the same function can be obtained. In the following embodiment, the description will be presented citing an inkjet printer (hereinafter referred to simply as a printer) for performing recording on a recording target medium using ink (a liquid) as an example. The scale size of each member is arbitrarily modified so as to provide a recognizable size to the member in the drawings used in the following description.

### First Embodiment

### [Printer 1]

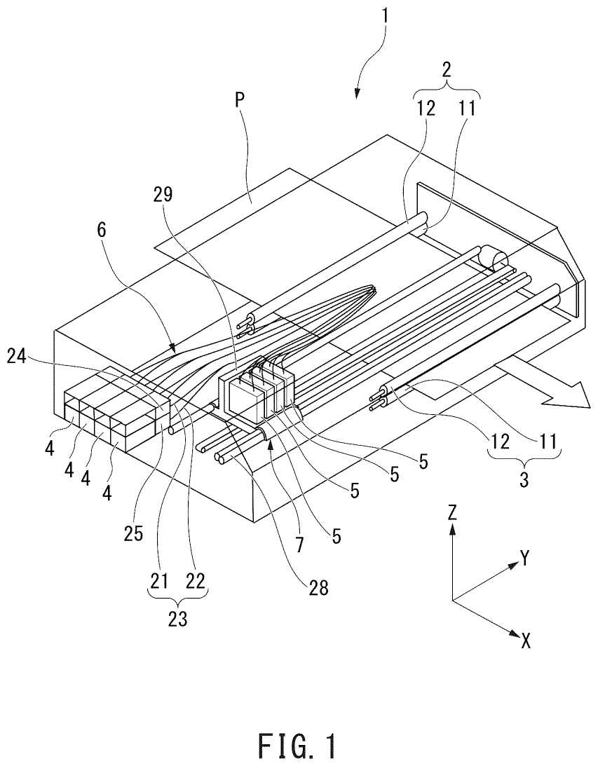

FIG. 1 is a schematic configuration diagram of a printer 1.

As shown in FIG. 1, the printer (a liquid jet recording device) 1 according to the first embodiment is provided with a pair of conveyance mechanisms 2, 3, ink tanks 4, inkjet heads (liquid jet heads) 5, ink circulation mechanisms 6, and a scanning mechanism 7.

In the following explanation, the description is presented using an orthogonal coordinate system of X, Y, and Z as needed. In this case, the X direction coincides with a conveying direction (a sub-scanning direction) of a recording target medium P (e.g., paper). The Y direction coincides with a scanning direction (a main scanning direction) of the scanning mechanism 7. The Z direction represents a height direction (a gravitational direction) perpendicular to the X direction and the Y direction. In the following explanation, the description will be presented defining an arrow side as a positive (+) side, and an opposite side to the arrow as a negative (−) side in the drawings in each of the X direction, the Y direction, and the Z direction. In the first embodiment, the +Z side corresponds to an upper side in the gravitational direction, and the −Z side corresponds to a lower side in the gravitational direction.

The conveyance mechanisms 2, 3 convey the recording target medium P toward the +X side. The conveyance mechanisms 2, 3 each include a pair of rollers 11, 12 extending in, for example, the Y direction.

The ink tanks 4 respectively contain ink of four colors such as yellow, magenta, cyan, and black. The inkjet heads 5 are configured so as to be able to respectively eject the four colors of ink, namely the yellow ink, the magenta ink, the cyan ink, and the black ink according to the ink tanks 4 coupled thereto.

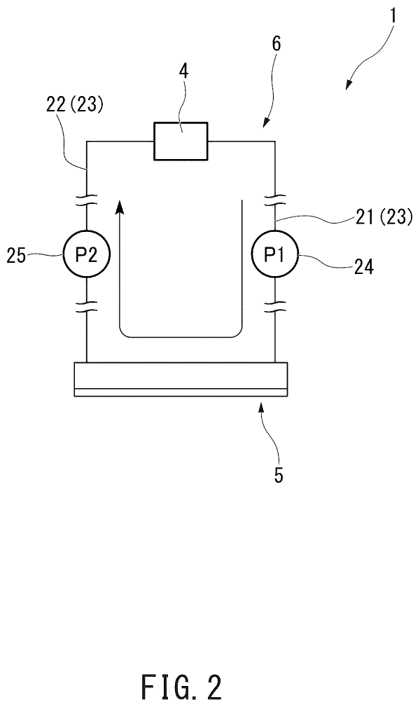

FIG. 2 is a schematic configuration diagram of the inkjet head 5 and the ink circulation mechanism 6.

As shown in FIGS. 1, 2, the ink circulation mechanism 6 circulates the ink between the ink tank 4 and the inkjet head 5. Specifically, the ink circulation mechanism 6 is provided with a circulation flow channel 23 having an ink supply tube 21 and an ink discharge tube 22, a pressure pump 24 coupled to the ink supply tube 21, and a suction pump 25 coupled to the ink discharge tube 22.

The pressure pump 24 pressurizes an inside of the ink supply tube 21 to deliver the ink to the inkjet head 5 through the ink supply tube 21. Thus, the ink supply tube 21 side is provided with positive pressure with respect to the inkjet head 5.

The suction pump 25 depressurizes the inside of the ink discharge tube 22 to suction the ink from the inkjet head 5 through the ink discharge tube 22. Thus, the ink discharge tube 22 side is provided with negative pressure with respect to the inkjet head 5. It is arranged that the ink can circulate between the inkjet head 5 and the ink tank 4 through the circulation flow channel 23 by driving the pressure pump 24 and the suction pump 25.

The scanning mechanism 7 makes the inkjet heads 5 perform a reciprocal scan in the Y direction. The scanning mechanism 7 is provided with a guide rail 28 extending in the Y direction, and a carriage 29 movably supported by the guide rail 28.

### <Inkjet Heads 5>

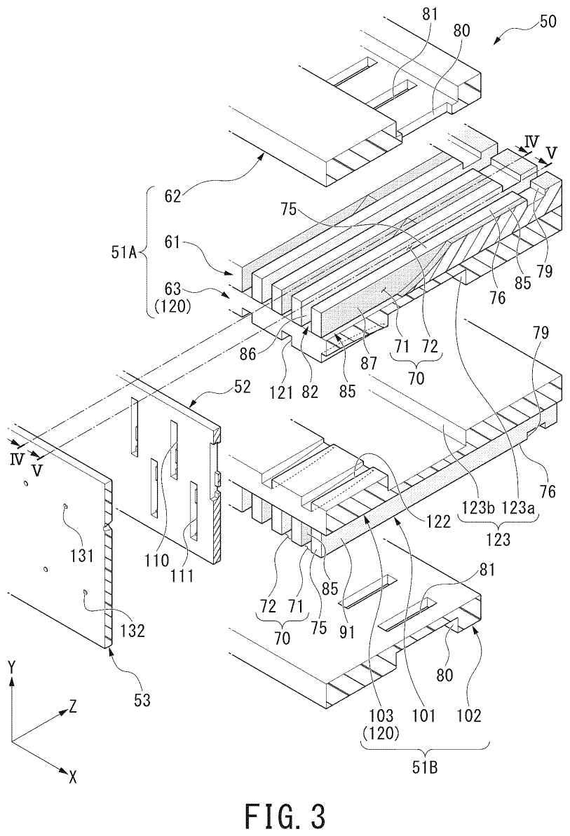

As shown in FIG. 1, the inkjet heads 5 are mounted on the carriage 29. In the illustrated example, the plurality of inkjet heads 5 is mounted on the single carriage 29 so as to be arranged side by side in the Y direction. The inkjet heads 5 are each provided with a head chip 50 (see FIG. 3), an ink supply unit (not shown) for coupling the ink circulation mechanism 6 and the head chip 50, and a control unit (not shown) for applying drive voltages to the head chip 50.

### <Head Chip 50>

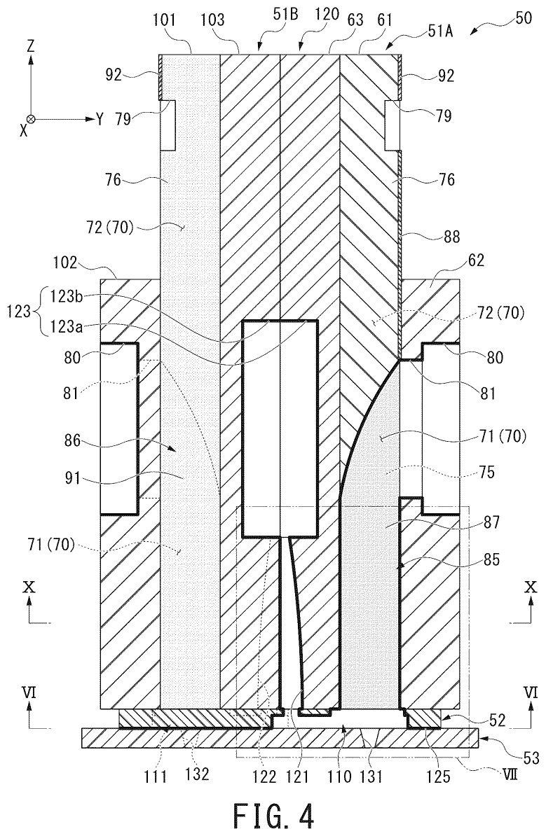

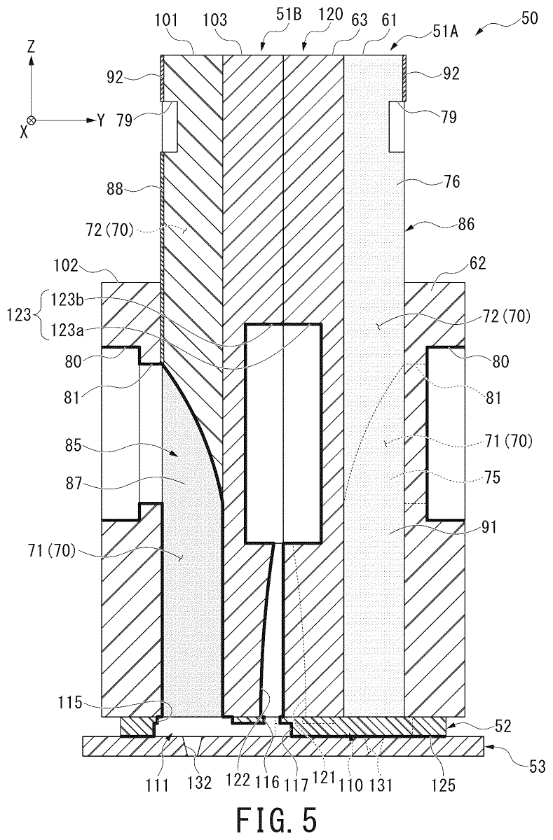

FIG. 3 is an exploded perspective view of the head chip 50. FIG. 4 is a cross-sectional view along the line IV-IV shown in FIG. 3. FIG. 5 is a cross-sectional view along the line V-V shown in FIG. 3.

As shown in FIG. 3 through FIG. 5, the head chip 50 is of a circulation type (a vertical circulation type) which circulates the ink with the ink tank 4 out of so-called edge-shoot types which eject the ink from a tip portion in a channel extension direction (the Z direction) in each of ejection channels 71 described later.

The head chip 50 is provided with a first chip module 51A, a second chip module 51B, a return plate 52, and a nozzle plate 53. In the following explanation, a configuration of each of the chip modules 51A, 51B will be described citing the first chip module 51A as an example. Therefore, the constituents in the second chip module 51B substantially the same as those of the first chip module 51A are denoted by the same reference symbols as in the first chip module 51A, and the description thereof will be omitted in some cases.

### <First Chip Module 51A>

The first chip module 51A is provided with a first actuator plate 61, a first cover plate 62, and a first back plate 63. In the following explanation, the first chip module 51A will be described defining the +Y side as an obverse surface side, and the −Y side as a reverse surface side.

The first actuator plate 61 is formed of a laminated substrate (a so-called chevron type) having two piezoelectric substrates which are different in polarization direction along the thickness direction (the Y direction) from each other, and are stacked on one another. It should be noted that as the piezoelectric substrates, there is preferably used a ceramics substrate formed of, for example, PZT (lead zirconate titanate). It should be noted that the first actuator plate 61 can be formed of a single piezoelectric substrate in which the polarization direction is set in a single direction (a so-called monopole type).

The first actuator plate 61 is provided with the ejection channels 71 each filled with the ink, and non-ejection channels 72 not filled with the ink. The channels 71, 72 are alternately arranged at intervals in the X direction in the first actuator plate 61 to thereby form a channel array 70. The configuration in which the channel extension direction coincides with the Z direction (an extension direction) will be described in the first embodiment, but the channel extension direction can cross the Z direction.

As shown in FIG. 3 and FIG. 4, the ejection channels 71 each have an upper end portion terminating within the first actuator plate 61, and a lower end portion opening on a lower end surface of the first actuator plate 61. Meanwhile, an upper part of each of the ejection channels 71 gradually shallows in depth in the Y direction along the upward direction. A lower part of each of the ejection channels 71 penetrates the first actuator plate 61 in the Y direction.

As shown in FIG. 3 and FIG. 5, the non-ejection channel 72 penetrates the first actuator plate 61 in the Z direction. The non-ejection channel 72 penetrates the first actuator plate 61 in the Y direction over the entire length in the Z direction. In other words, the depth in the Y direction in the non-ejection channel 72 is uniform throughout the entire length in the Z direction.

In the first actuator plate 61, a portion located between each of the ejection channels 71 and corresponding one of the non-ejection channels 72 constitutes a drive wall 75. Therefore, both sides in the X direction of the ejection channel 71 are surrounded by the pair of drive walls 75. In the first actuator plate 61, a portion located above the ejection channel 71 constitutes a tail part 76.

### <First Cover Plate 62>

As shown in FIG. 3 through FIG. 5, the first cover plate 62 is bonded to the obverse surface of the first actuator plate 61. Specifically, the first cover plate 62 closes the obverse surface-side openings of the channels 71, 72 in a state of exposing the obverse surfaces of the tail parts 76. A lower end surface of the first cover plate 62 is arranged so as to be coplanar with the lower end surface of the first actuator plate 61.

In the first cover plate 62, at positions overlapping the upper parts of the ejection channels 71 when viewed from the Y direction, there is formed a common ink chamber 80. The common ink chamber 80 extends in the X direction with a length sufficient for straddling, for example, the channel array 70, and at the same time, opens on the obverse surface of the first cover plate 62. The common ink chamber 80 is indirectly connected to the ink supply tube 21 through an entrance port not shown.

In the common ink chamber 80, at the positions overlapping the upper parts of the respective ejection channels 71 when viewed from the Y direction, there are individually formed slits 81. The slits 81 each communicate the inside of the ejection channel 71 and the inside of the common ink chamber 80 with each other through the upper part of the ejection channel 71. Therefore, the common ink chamber 80 is communicated with the ejection channels 71 through the respective slits 81 on the one hand, but is not communicated with the non-ejection channels 72 on the other hand.

### <First Back Plate 63>

The first back plate 63 is bonded to a reverse surface of the first actuator plate 61. The first back plate 63 has an equivalent outer shape to that of the first actuator plate 61 when viewed from the Y direction. The first back plate 63 is overlapped with the whole of the first actuator plate 61 when viewed from the Y direction. In other words, the first back plate 63 closes reverse surface side openings of the channels 71, 72.

As shown in FIG. 3, the first actuator plate 61 is provided with common wiring lines 85 and individual wiring lines 86 as drive wiring lines.

As shown in FIG. 3 and FIG. 4, the common wiring lines 85 are each provided with a common electrode 87 and a common terminal 88.

The common electrode 87 is formed on inner side surfaces opposed to each other in the X direction out of the inner surfaces of the ejection channel 71. In the illustrated example, the common electrode 87 is formed throughout the entire area in the Y direction and the Z direction on the inner side surfaces of the ejection channel 71. It should be noted that it is sufficient for the common electrode 87 to be provided to at least a portion located below the lower-end opening edge of the slit 81 out of the inner side surface of the ejection channel 71.

The common terminal 88 is formed on an obverse surface of the tail part 76. The common terminal 88 is disposed on the obverse surface of the tail part 76 so as to correspond to each of the ejection channels 71. Each of the common terminals 88 extends linearly in the Z direction above corresponding one of the ejection channels 71. The lower end portion in the common terminal 88 is connected to the common electrode 87 in an upper-end opening edge of the ejection channel 71.

As shown in FIG. 3 and FIG. 5, the individual wiring lines 86 are each provided with individual electrodes 91, and an individual terminal 92.

The individual electrodes 91 are each formed on one of the inner side surfaces opposed to each other in the X direction out of the inner surfaces of each of the non-ejection channels 72. In the illustrated example, the individual electrode 91 is formed throughout the entire area in the Y direction and the Z direction on the inner side surface of the non-ejection channel 72. It should be noted that it is sufficient for the individual electrode 91 to be formed at a position opposed to the common electrode 87 in at least a portion located below the lower-end opening edge of the slit 81.

The individual terminal 92 is provided to a portion located above the common terminal 88 on the obverse surface of the tail part 76. The individual terminal 92 is formed to have a strip shape extending in the X direction. The individual terminal 92 couples the individual electrodes 91, which are opposed to each other in the X direction across the ejection channel 71, to each other at obverse surface side opening edges of the non-ejection channels 72, which are opposed to each other in the X direction across the ejection channel 71. In the tail part 76, in a portion located between the common terminal 88 and the individual terminal 92, there is formed a dividing groove 79. The dividing groove 79 opens on the obverse surface of the tail part 76, and at the same time, extends in the X direction. The dividing groove 79 separates the common terminal 88 and the individual terminal 92 from each other. The dividing groove 79 is formed to have a depth in the Y direction smaller than a half of the thickness of the first actuator plate 61. It should be noted that the depth of the dividing groove 79 can be changed as appropriate within a range in which the individual electrode 91 is not cut.

To the obverse surface of the tail part 76, there is pressure-bonded a flexible printed board (not shown). The flexible printed board is coupled to the common terminals 88 and the individual terminals 92 on the obverse surfaces of the tail parts 76. The flexible printed board couples the first chip module 51A and the control unit to each other.

### <Second Chip Module 51B>

The second chip module 51B is provided with a second actuator plate 101, a second cover plate 102, and a second back plate 103. The second chip module 51B has the second back plate 103, the second actuator plate 101, and the second cover plate 102 overlapped in sequence from the +Y side toward the −Y side. The second chip module 51B is overlapped with the first chip module 51A in a state in which the obverse surface side (the −Y side) faces to an opposite side to the first chip module 51A. Specifically, the first chip module 51A and the second chip module 51B are integrated with each other by the reverse surfaces of the first back plate 63 and the second back plate 103 being bonded to each other. In this case, the lower end surfaces of the respective chip modules 51A, 51B are arranged so as to be coplanar with each other.

The ejection channels 71 and the non-ejection channels 72 of the second chip module 51B are arranged so as to be shifted as much as a half pitch with respect to the arrangement pitch of the ejection channels 71 and the non-ejection channels 72 of the first chip module 51A. In other words, the ejection channels 71 of the chip modules 51A, 51B, and the non-ejection channels 72 of the chip modules 51A, 51B are each arranged in a zigzag manner. In this case, the ejection channels 71 of the first chip module 51A and the non-ejection channels 72 of the second chip module 51B face each other in the Y direction, and the non-ejection channels 72 of the first chip module 51A and the ejection channels 71 of the second chip module 51B face each other in the Y direction. It should be noted that the pitch of the channels 71, 72 in each of the chip modules 51A, 51B can be changed as appropriate.

### <Return Plate 52>

The return plate 52 is bonded to the lower end surfaces of the respective chip modules 51A, 51B in a lump via an adhesive. The return plate 52 closes the lower end opening parts of the respective channels 71, 72. The return plate 52 is formed of, for example, polyimide. The return plate 52 is provided with a plurality of first communication channels 110 and a plurality of second communication channels 111. It should be noted that the first communication channels 110 and the second communication channels 111 are formed of a plurality of lines of laser irradiation traces as described later in the manufacturing method. It should be noted that in FIG. 4 to FIG. 7, inner surface shapes of the first communication channels 110 and the second communication channels 111 are shown as smooth surfaces for the sake of convenience.

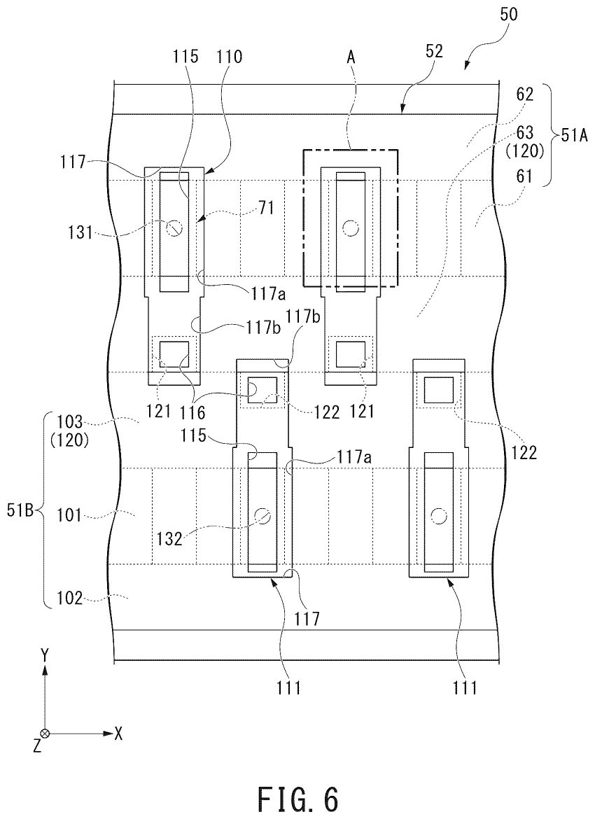

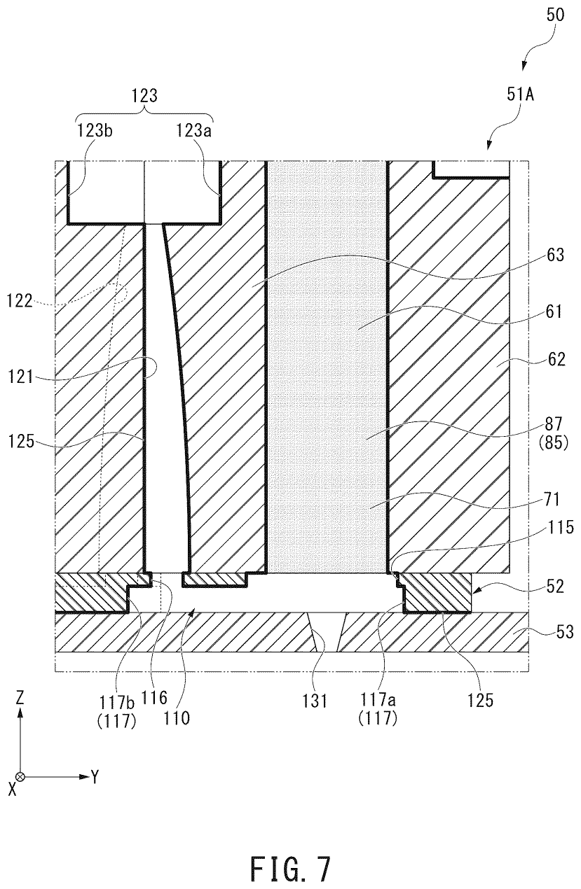

FIG. 6 is a cross-sectional view corresponding to the line VI-VI shown in FIG. 4. FIG. 7 is an enlarged view of the VII portion shown in FIG. 4.

As shown in FIG. 6 and FIG. 7, the plurality of first communication channels 110 is formed individually at equivalent positions in the X direction to those of the respective ejection channels 71 in the first chip module 51A. In the first embodiment, the plurality of first communication channels 110 is formed at intervals in the X direction so as to correspond to the arrangement pitch of the ejection channels 71. Each of the first communication channels 110 is a recess formed to have a U-shape in a side view viewed from the X direction. Specifically, each of the first communication channels 110 is provided with an upstream opening (penetrating part) 115, a downstream opening (penetrating part) 116, and a connecting part (non-penetrating part) 117. Since the first communication channels 110 have substantially the same configurations, in the following configuration, the details of the first communication channels 110 will be described citing one of the first communication channels 110 as an example.

The upstream opening 115 is formed at a position overlapping the ejection channel 71 when viewed from the Z direction. The upstream opening 115 has an upper end portion opening on an upper surface of the return plate 52, and a lower end portion terminating in the return plate 52. The upstream opening 115 is communicated with the inside of the ejection channel 71 through the lower-end opening of the ejection channel 71.

At least a part of an opening edge of the upstream opening 115 is arranged at an outer side of a lower-end opening edge of the ejection channel 71 when viewed from the Z direction. Specifically, a dimension in the X direction in the upstream opening 115 is smaller than a dimension in the X direction in the lower end opening of the ejection channel 71. A dimension in the Y direction in the upstream opening 115 is larger than a dimension in the Y direction in the lower end opening of the ejection channel 71. In the lower end surface of the first chip module 51A, portions located at both sides in the Y direction with respect to the ejection channel 71 are exposed through the upstream opening 115.

The downstream opening 116 is formed at a position overlapping the first back plate 63 when viewed from the Z direction. The downstream opening 116 has an upper end portion opening on the upper surface of the return plate 52, and a lower end portion terminating in the return plate 52. A dimension in the Z direction in the downstream opening 116 is made equivalent to that of the upstream opening 115.

The connecting part 117 opens only on the lower surface of the return plate 52, and at the same time, communicates the upstream opening 115 and the downstream opening 116 with each other. The connecting part 117 is formed to have a rectangular shape having a transverse direction set to the X direction and a longitudinal direction set to the Y direction when viewed from the Z direction. In the first embodiment, the dimension in the Z direction in the connecting part 117 is larger than the dimensions in the Z direction in the upstream opening 115 and the downstream opening 116. It should be noted that the dimension in the Z direction in the connecting part 117 may be made different in accordance with a position in the Y direction.

The connecting part 117 is larger in dimension in the X direction than the upstream opening 115 and the downstream opening 116 when viewed from the Z direction. Specifically, the connecting part 117 is provided with an upstream wide part 117a and a downstream wide part 117b.

The upstream wide part 117a is arranged at a position overlapping the upstream opening 115 when viewed from the Z direction. The upstream wide part 117a is made one size larger than the upstream opening 115 when viewed from the Z direction. The upstream opening 115 opens on a surface (a bottom surface) facing downward out of the inner surfaces of the upstream wide part 117a. Therefore, the upstream opening 115 penetrates the return plate 52 in the Z direction via the upstream wide part 117a.

The downstream wide part 117b extends toward the −Y side from the upstream wide part 117a. The downstream wide part 117b overlaps the downstream opening 116 when viewed from the Z direction. The downstream wide part 117b is made one size larger than the downstream opening 116 when viewed from the Z direction. A dimension in the X direction in the downstream wide part 117b is made smaller than that of the upstream wide part 117a. The downstream opening 116 opens on the bottom surface of the downstream wide part 117b. Therefore, the downstream opening 116 penetrates the return plate 52 in the Z direction via the downstream wide part 117b.

As shown in FIG. 5, the plurality of second communication channels 111 is formed individually at equivalent positions in the X direction to those of the respective ejection channels 71 in the second chip module 51B. In the first embodiment, the plurality of second communication channels 111 is formed at intervals in the X direction so as to correspond to the arrangement pitch of the ejection channels 71 of the second chip module 51B. Specifically, the first communication channels 110 and the second communication channels 111 are alternately arranged at intervals in the X direction. It should be noted that the second communication channels 111 have substantially the same configuration as that of the first communication channels 110. Therefore, substantially the same constituents of the second communication channels 111 as those of the first communication channels 110 are denoted by the same reference symbols to omit the detailed description of the second communication channels 111.

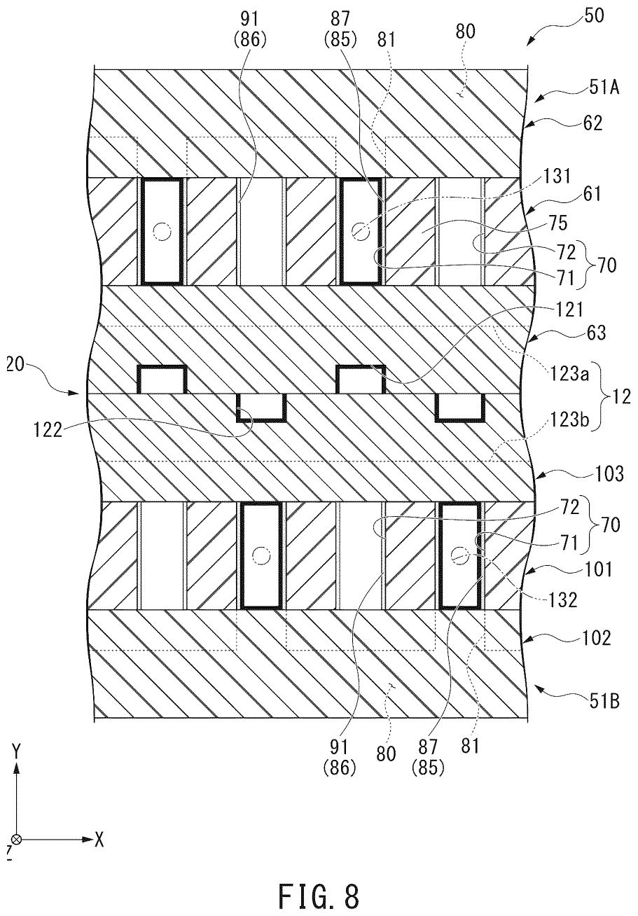

FIG. 8 is a cross-sectional view corresponding to the line VIII-VIII shown in FIG. 4.

As shown in FIG. 4 and FIG. 8, the first back plate 63 and the second back plate 103 constitute a flow channel plate 120 in a state in which the first back plate 63 and the second back plate 103 overlap each other. The flow channel plate 120 is provided with a plurality of first connecting channels 121, a plurality of second connecting channels 122, and a manifold 123.

The plurality of first connecting channels 121 is formed individually at positions overlapping the downstream openings 116 of the respective first communication channels 110 when viewed from the Z direction. The first connecting channels 121 are arranged at intervals in the X direction at the same pitch as that of the first communication channels 110. Specifically, the first connecting channels 121 open on the reverse surface of the first back plate 63. The reverse surface side openings in the first connecting channels 121 are closed by the second back plate 103.

The first connecting channels 121 each extend linearly in the Z direction when viewed from the Y direction. A lower end portion in each of the first connecting channels 121 opens on the lower end surface of the first back plate 63. Thus, the lower end opening of each of the first connecting channels 121 is communicated with the downstream opening 116. In contrast, an upper end portion in each of the first connecting channels 121 terminates in the first back plate 63.

As shown in FIG. 6, the lower end opening of each of the first connecting channels 121 is made larger in dimension in the X direction than the downstream opening 116, and is made smaller in dimension in the X direction than the downstream wide part 117b. In this case, an opening edge of the downstream opening 116 flares to the inside of the lower-end opening edge of the first connecting channel 121. However, it is possible for the lower end opening in each of the first connecting channels 121 to be made larger in dimension in the X direction than the downstream wide part 117b, or made smaller in dimension in the X direction than the downstream opening 116.

As shown in FIG. 8, the plurality of second connecting channels 122 is formed individually at positions overlapping the downstream openings 116 of the respective second communication channels 111 when viewed from the Z direction. The second connecting channels 122 are arranged at intervals in the X direction at the same pitch as that of the second communication channels 111. Specifically, the first connecting channels 121 and the second connecting channels 122 are alternately arranged in the X direction.

As shown in FIG. 5 and FIG. 6, each of the second connecting channels 122 is communicated with the downstream opening 116 of corresponding one of the second communication channels 111. Specifically, the second connecting channels 122 open on the reverse surface (a surface facing to the +Y side) of the second back plate 103. The reverse surface side openings in the second connecting channels 122 are closed by the first back plate 63. The second connecting channels 122 extend in the Z direction. A lower end portion in each of the second connecting channels 122 opens on the lower end surface of the second back plate 103. Thus, the lower end opening of each of the second connecting channels 122 is communicated with the downstream opening 116 of corresponding one of the second communication channels 111. In contrast, an upper end portion in each of the second connecting channels 122 terminates in the second back plate 103. It should be noted that it is possible to set the dimensions and so on of the second connecting channels 122 to substantially the same as those of the first connecting channels 121.

The manifold 123 is provided to a portion located above the connecting channels 121, 122 in the flow channel plate 120. The manifold 123 is formed by overlapping a first recess 123a provided to the first back plate 63 and a second recess 123b provided to the second back plate 103 each other. The first recess 123a is a recess which opens on the reverse surface of the first back plate 63, and which extends in the Z direction and the Y direction. The second recess 123b is a recess which opens on the reverse surface of the second back plate 103, and which extends in the Z direction and the Y direction. The manifold 123 is formed by communicating the reverse surface side openings of the first recess 123a and the second recess 123b with each other. It should be noted that the manifold 123 may be provided with a configuration in which a recess provided to either one of the first back plate 63 and the second back plate 103 is closed by the reverse surface of the other of the back plates.

The connecting channels 121, 122 are communicated in a lump with the manifold 123. Specifically, the upper end opening of each of the first connecting channels 121 opens on the lower end surface of the first recess 123a. An upper end opening of each of the second connecting channels 122 opens on the lower end surface of the second recess 123b. It should be noted that the manifold 123 is indirectly connected to the ink discharge tube 22 through an exit port not shown.

The chip modules 51A, 51B and the return plate 52 are covered with protective films 125. In the first embodiment, the protective films 125 are also formed on an inner surface of the common ink chamber 80, inner surfaces of the slits 81, inner surfaces of the ejection channels 71, inner surfaces of the communication channels 110, 111, inner surfaces of the connecting channels 121, 122, and an inner surface of the manifold 123. The protective films 125 each include an organic insulating material such as a para-xylylene resin material (e.g., parylene (a registered trademark)) as a material having an insulating property. The protective films 125 can be formed of tantalum oxide (Ta₂O₅), silicon nitride (SiN), silicon carbide (SiC), silicon oxide (SiO₂), diamond-like carbon, or the like, or can include at least any one of these materials.

### <Nozzle Plate 53>

As shown in FIG. 3 through FIG. 5, the nozzle plate 53 is bonded to the lower end surface of the return plate 52. A plurality of nozzle holes (first nozzle holes 131 and second nozzle holes 132) each penetrating the nozzle plate 53 in the Z direction is arranged in the nozzle plate 53.

In the nozzle plate 53, the plurality of first nozzle holes 131 is formed individually at positions overlapping the respective first communication channels 110 when viewed from the Z direction. In other words, the first nozzle holes 131 are arranged at intervals in the X direction at the same pitch as that of the first communication channels 110. The first nozzle holes 131 are communicated with the corresponding ejection channels 71 of the first chip module 51A through the corresponding first communication channels 110, respectively. Specifically, the first nozzle holes 131 are each formed at a position overlapping the ejection channel 71 and the upstream wide part 117a when viewed from the Z direction in a +Y-side end portion in corresponding one of the first communication channels 110. It should be noted that the first nozzle holes 131 can be communicated with the first communication channels 110 at positions shifted in the Y direction from the ejection channels 71 of the first chip module 51A, respectively.

In the nozzle plate 53, the plurality of second nozzle holes 132 is formed individually at positions overlapping the respective second communication channels 111 when viewed from the Z direction. In other words, the second nozzle holes 132 are arranged at intervals in the X direction at the same pitch as that of the second communication channels 111. The second nozzle holes 132 are communicated with the corresponding ejection channels 71 of the second chip module 51B through the corresponding second communication channels 111, respectively. Specifically, the second nozzle holes 132 are each formed at a position overlapping the ejection channel 71 and the upstream wide part 117a when viewed from the Z direction in a −Y-side end portion in corresponding one of the second communication channels 111. It should be noted that the second nozzle holes 132 may be communicated with the second communication channels 111 at positions shifted in the Y direction from the ejection channels 71 of the second chip module 51B, respectively.

### [Operation Method of Printer 1]

Then, there will hereinafter be described when recording a character, a figure, or the like on the recording target medium P using the printer 1 configured as described above.

It should be noted that it is assumed that as an initial state, the sufficient ink having colors different from each other is respectively encapsulated in the four ink tanks 4 shown in FIG. 1. Further, there is provided a state in which the inkjet heads 5 are filled with the ink in the ink tanks 4 via the ink circulation mechanisms 6, respectively.

Under such an initial state, when making the printer I operate, the recording target medium P is conveyed toward the +X side while being pinched by the rollers 11, 12. By the carriage 29 moving in the Y direction at the same time as the conveyance of the recording target medium P, the inkjet heads 5 mounted on the carriage 29 make a reciprocal motion in the Y direction.

Here, the operation of each of the inkjet heads 5 will hereinafter be described in detail.

In such a vertically circulating type head chip 50 as in the first embodiment, first, by making the pressure pump 24 and the suction pump 25 shown in FIG. 2 operate, the ink is circulated in the circulation flow channel 23. In this case, the ink circulating through the ink supply tube 21 flows into the common ink chamber 80 of each of chip modules 51 through the entrance port. The ink having flowed into the common ink chambers 80 is supplied to the inside of each of the ejection channels through the slit 81. The ink having flowed into the ejection channels 71 gathers in the manifold 123 through the communication channels 110, 111 and the connecting channels 121, 122, and is then discharged to the ink discharge tube 22 through the exit port. The ink discharged to the ink discharge tube 22 is returned to the ink tank 4, and is then supplied again to the ink supply tube 21. Thus, the ink is circulated between the inkjet head 5 and the ink tank 4.

Then, when the reciprocation is started by the carriage 29, the drive voltages are applied to the electrodes 87, 91 via the flexible boards. On this occasion, the drive voltage is applied between the electrodes 87, 91 by setting the individual electrode 91 at a drive potential Vdd, and the common electrode 87 at a reference potential GND. Then, a thickness shear deformation occurs in the two drive walls 75 partitioning the ejection channel 71, and the two drive walls 75 each deform so as to protrude toward the non-ejection channel 72. Specifically, the actuator plates 61, 101 in the first embodiment each have two piezoelectric substrates on which the polarization treatment has been performed in the thickness direction (the Y direction), and which are stacked on one another, and therefore, by applying the drive voltage, the actuator plates 61, 101 each make a flexural deformation having a V-shape centering on an intermediate position in the Y direction in the drive walls 75. Thus, the ejection channel 71 deforms as if it bulges.

When the volume of the ejection channel 71 increases due to the deformation of the two drive walls 75, the ink in the common ink chamber 80 is induced into the ejection channel 71 through the slit 81. Then, the ink induced to the inside of the ejection channel 71 propagates to the inside of the ejection channel 71 as a pressure wave, and the drive voltage applied between the electrodes 87, 91 is set to zero at the timing at which the pressure wave reaches the nozzle hole 131, 132.

Thus, the drive walls 75 are restored, and the volume of the ejection channel 71 having once increased is restored to the original volume. Due to this operation, the internal pressure of the ejection channel 71 increases to pressurize the ink. As a result, it is possible to eject the ink from the nozzle hole 131, 132. On this occasion, the ink turns to an ink droplet having a droplet shape when passing through the nozzle hole 131, 132, and is then ejected. Thus, it is possible to record a character, an image, or the like on the recording target medium P as described above. In other words, in the head chip 50 according to the first embodiment, out of the ink flowing through each of the communication channels 110, 111, a part is ejected through corresponding one of the nozzle holes 131, 132, while the rest is returned to the manifold 123 through corresponding one of the connecting channels 121, 122.

### [Method of Manufacturing Head Chip 50]

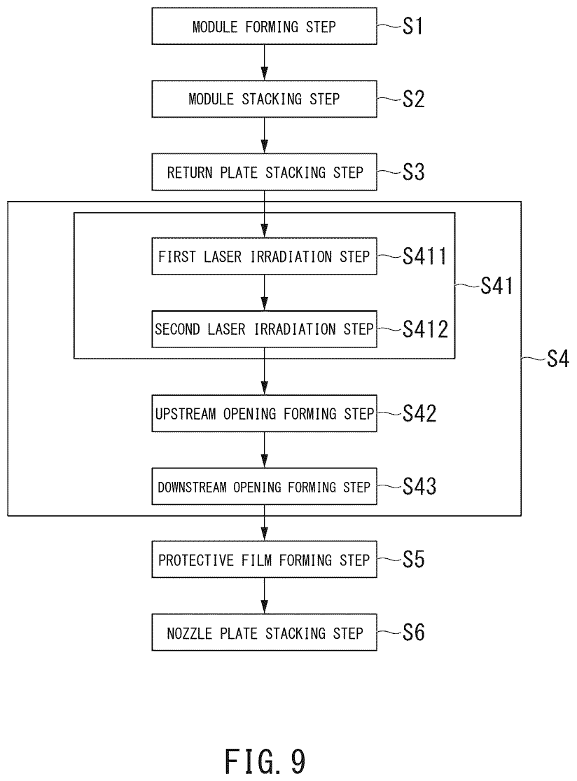

Then, a method of manufacturing the head chip 50 described above will be described. FIG. 9 is a flowchart illustrating the method of manufacturing the head chip 50. In the following description, there is described when manufacturing the head chip 50 chip by chip as an example for the sake of convenience.

As shown in FIG. 9, the method of manufacturing the head chip 50 is provided with a module forming step S1, a module stacking step S2, a return plate stacking step S3, a return plate processing step S4, a protective film forming step S5, and a nozzle plate stacking step S6.

In the module forming step S1, each of the first chip module 51A and the second chip module 51B is formed.

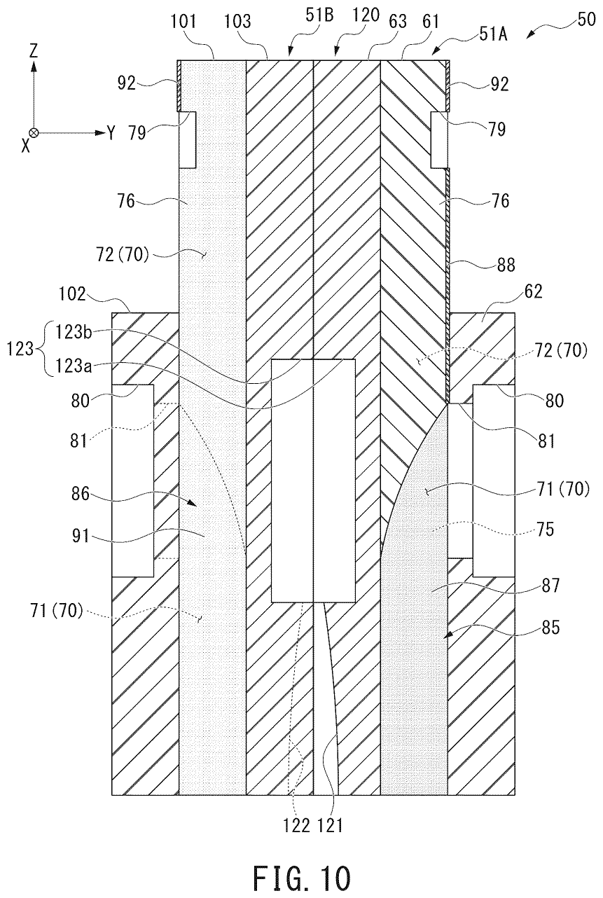

FIG. 10 through FIG. 12 are each a process diagram illustrating the method of manufacturing the head chip 50, and are each a cross-sectional view corresponding to FIG. 4.

As shown in FIG. 10, in the module stacking step S2, the chip modules 51A, 51B formed in the module forming step S1 are bonded to each other. Specifically, the reverse surfaces of the back plates 63, 103 are bonded to each other in a state in which the lower end surfaces of the respective chip modules 51A, 51B coincide with each other. Thus, the reverse side openings of the first connecting channels 121 are closed by the second back plate 103, the reverse side openings of the second connecting channels 122 are closed by the first back plate 63, and at the same time, the manifold 123 is formed with the first recess 123a and the second recess 123b. Thus, the stacked body of the chip modules 51A, 51B is formed.

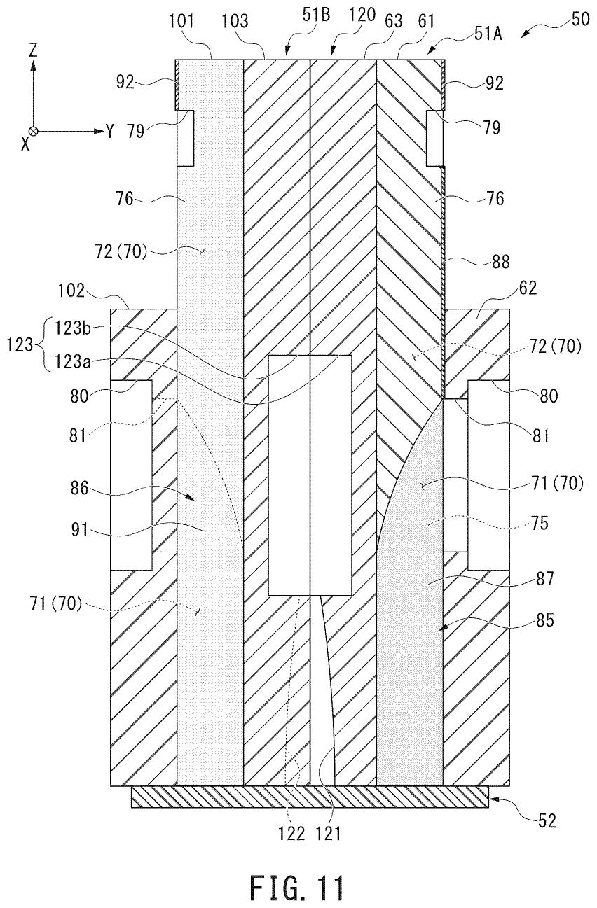

As shown in FIG. 11, in the return plate stacking step S3, the return plate 52 is bonded to a lower end surface in the stacked body of the chip modules 51A, 51B.

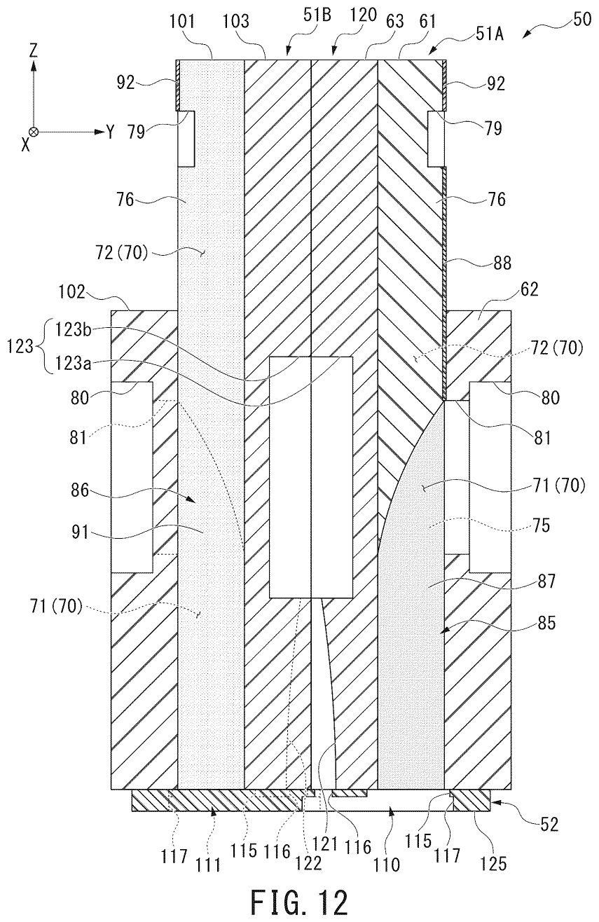

As shown in FIG. 12, in the return plate processing step S4, the communication channels 110, 111 are provided to portions of the return plate 52 overlapping the ejection channels 71 when viewed from the Z direction. The communication channels 110, 111 are formed by performing, for example, laser processing on the return plate 52. It should be noted that the communication channels 110, 111 are both formed by substantially the same method. Therefore, the method of forming the communication channels 110, 111 will hereinafter be described using the first communication channel 110 as an example.

The return plate processing step S4 is provided with a connecting part forming step S41, an upstream opening forming step S42, and a downstream opening forming step S43.

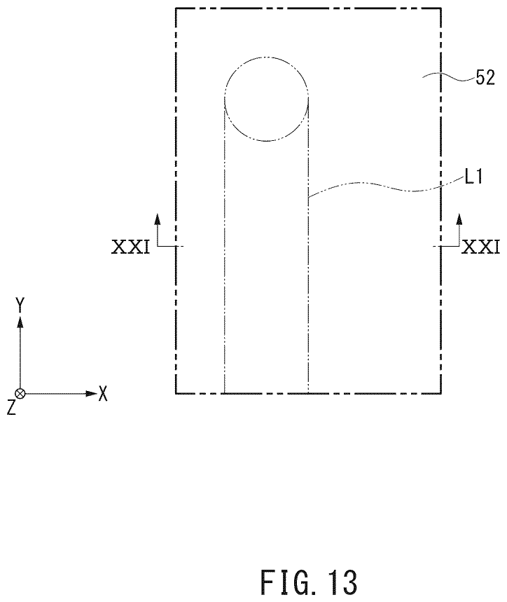

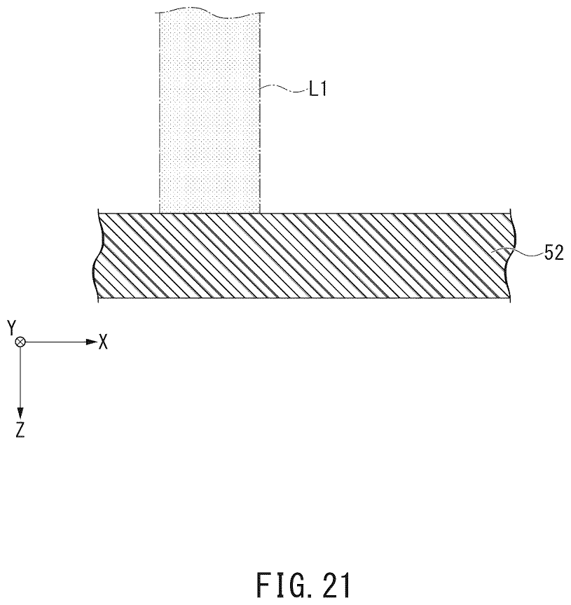

FIG. 13 to FIG. 28 are process diagrams of the connecting part forming step S41. Out of FIG. 13 to FIG. 28, FIG. 13 to FIG. 20 are each a bottom view of a portion corresponding to a portion A in FIG. 6 of the return plate 52. Out of FIG. 13 to FIG. 28, FIG. 21 to FIG. 28 are each a cross-sectional view of the return plate 52. The correspondence relationship between FIG. 21 to FIG. 28 and FIG. 13 to FIG. 20 is as the cross-section pointing lines denoted by the roman numerals in FIG. 13 to FIG. 20, respectively.

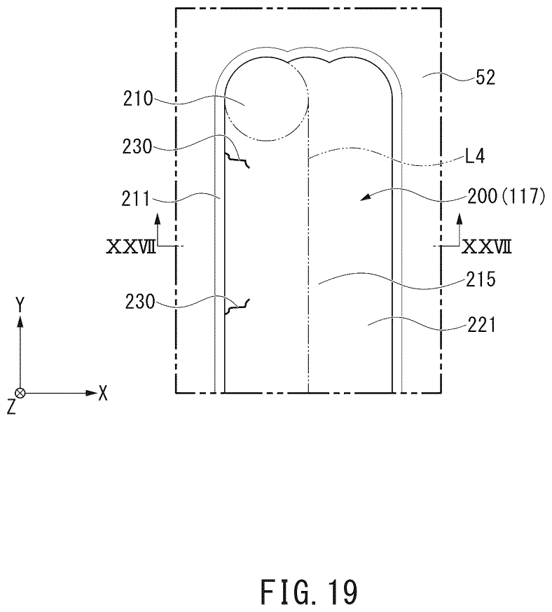

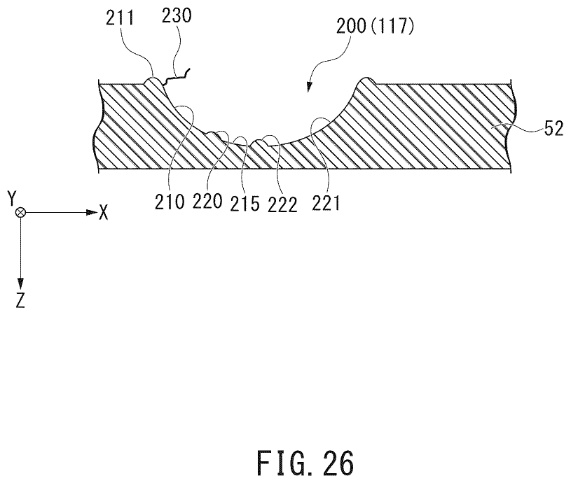

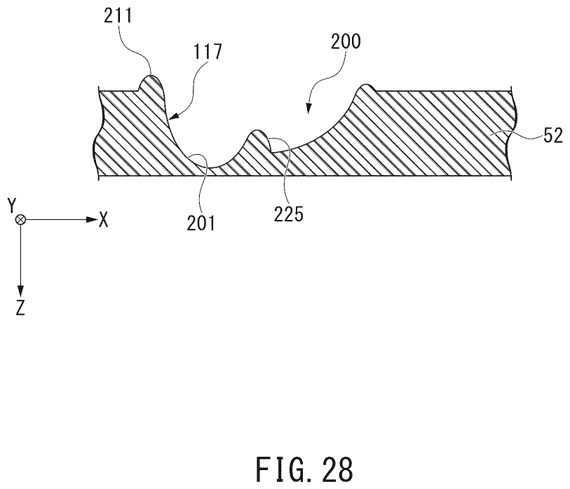

In the connecting part forming step S41, the connecting parts 117 are formed by a first laser irradiation step S411 and a second laser irradiation step S412. Specifically, the connecting parts 117 are each formed of an outer shape part 200 (see FIG. 19 and FIG. 26) which remains after the first laser irradiation step S411, and an additional-processing laser irradiation trace (a second laser irradiation trace) 201 (see FIG. 28) which remains after the second laser irradiation step S412.

As shown in FIG. 13 and FIG. 21, in the first laser irradiation step S411, by irradiating a surface facing to the −Z side (a lower surface) of the return plate 52 with the laser beam, the outer shape part 200 which becomes an outer shape in a plan view of the connecting part 117 is formed. Specifically, by setting the Y direction as a laser scanning direction, and setting the X direction as a pitch direction (a column direction), scanning with the laser beam is performed over a plurality of columns. Therefore, the length in the Y direction in the connecting part 117 can be adjusted in accordance with the scanning range with the laser beam. Meanwhile, the width in the X direction in the connecting part 117 can be adjusted with the number of columns of the laser irradiation in a central column which is performed between the laser irradiation in a starting column and the laser irradiation in the last column, a laser diameter of the laser beam, an offset amount of the laser beam between columns adjacent to each other, and so on. In the first embodiment, the laser diameters in the respective columns are equivalent to each other (e.g., about 10 μm). However, the laser diameter may be changed by the columns.

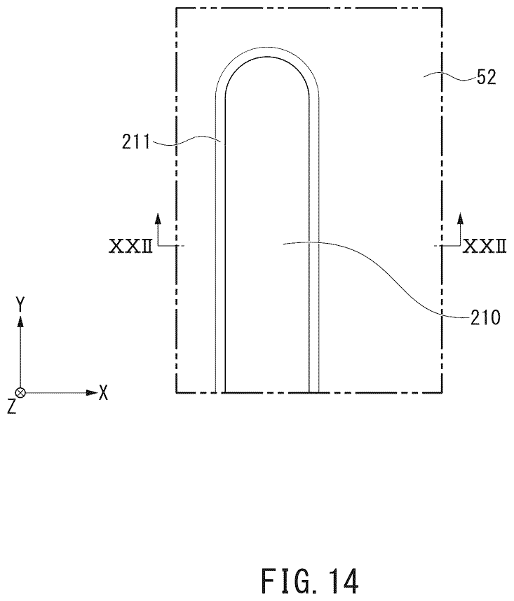

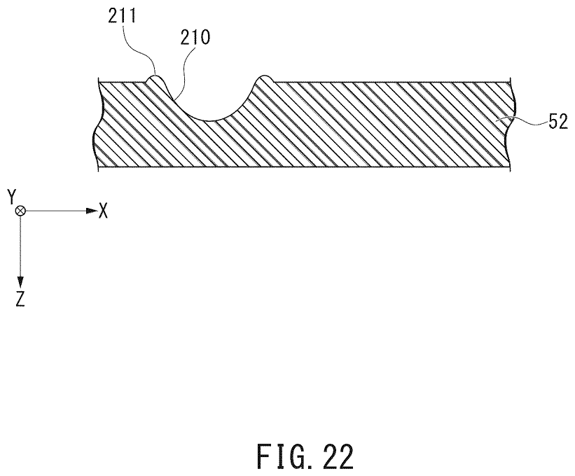

In the first laser irradiation step S411, first, irradiation with a starting-column laser beam L1 is performed. Specifically, by scanning a position corresponding to a −X-side end portion of the connecting part 117 in the lower surface of the return plate 52 with the starting-column laser beam L1 along the Y direction, a starting-column irradiation trace (a first laser irradiation trace) 210 shown in FIG. 14 and FIG. 22 is formed. As shown in FIG. 14, the starting-column irradiation trace 210 extends linearly along the Y direction in the plan view. As shown in FIG. 22, the starting-column irradiation trace 210 is recessed in a semicircular shape with respect to a lower surface of the return plate 52 when viewed from the Y direction. It should be noted that the width of the starting-column irradiation trace 210 is made slightly larger than the laser diameter since an influence of the heat of the starting-column laser beam L1 propagates to an outside range of the laser diameter.

Incidentally, there is a possibility that a portion (hereinafter referred to as a “wrinkle”) protruding from an opening edge of the laser irradiation trace is formed after the laser irradiation. In this case, for example, an outer peripheral wrinkle 211 which protrudes from the lower surface of the return plate 52 is formed on the opening edge of the starting-column irradiation trace 210 after forming the starting-column irradiation trace 210. The outer peripheral wrinkle 211 extends throughout the entire circumference of the starting-column irradiation trace 210 so as to surround the starting-column irradiation trace 210.

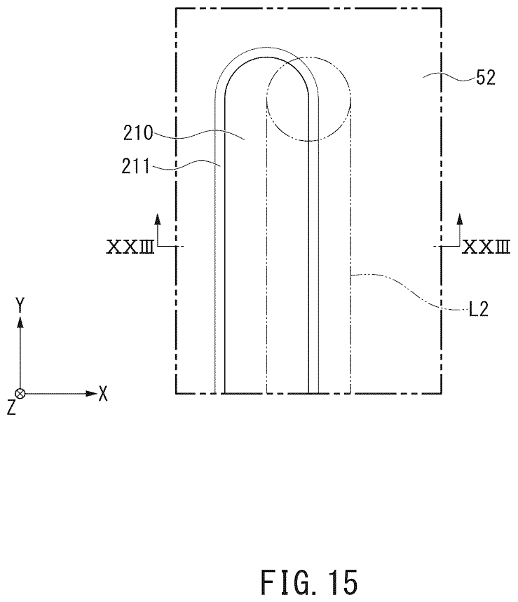

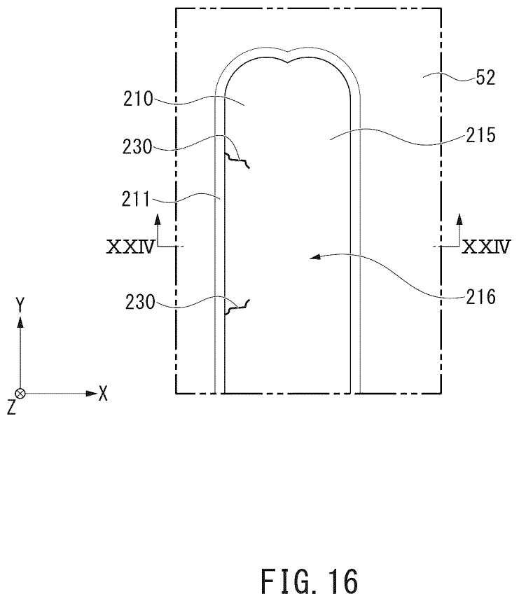

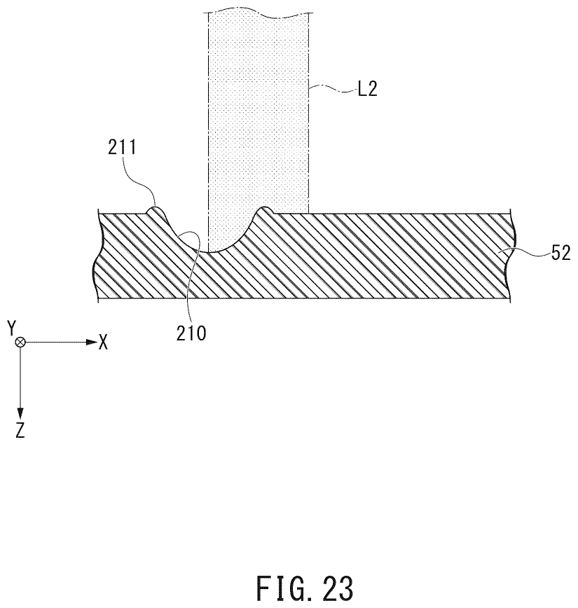

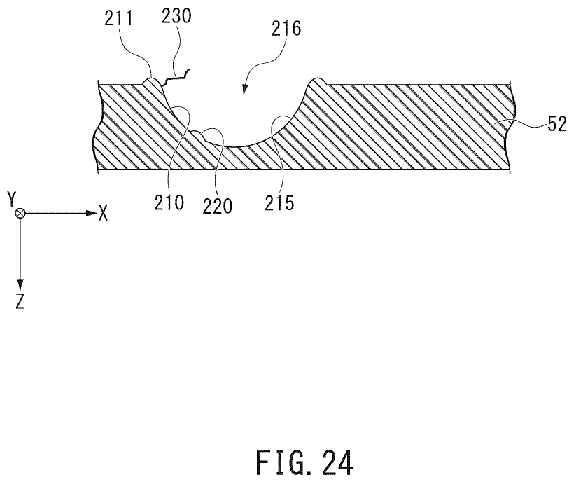

Subsequently, as shown in FIG. 15 and FIG. 23, by performing scanning with a second-column (central-column) laser beam L2, a central-column irradiation trace (the first laser irradiation trace) 215 shown in FIG. 16 and FIG. 24 is formed. As shown in FIG. 15 and FIG. 23, the scanning with the central-column laser beam L2 is performed while the center of the laser diameter in the central-column laser beam L2 is provided with an offset toward the +X side with respect to the center of the laser diameter in the previous column (the starting-column laser beam L1). In the first embodiment, an amount of the offset of the central-column laser beam L2 is, for example, a half of the laser diameter (half pitch). However, the amount of the offset of the central-column laser beam L2 can be changed as appropriate as long as the amount of the offset is within a range in which the starting-column irradiation trace 210 and the central-column irradiation trace 215 partially overlap each other.

The central-column irradiation trace 215 is formed so as to overlap the +X-side end portion of the laser irradiation trace in the previous column (the starting-column irradiation trace 210) to thereby form an intermediate recess 216 together with the starting-column irradiation trace 210. As shown in FIG. 16, the central-column irradiation trace 215 extends in parallel to the starting-column irradiation trace 210 in a state of being connected to the starting-column irradiation trace 210 in the plan view. As shown in FIG. 24, a central-column irradiation trace 215 is recessed in a circular-arc shape with respect to the lower surface of the return plate 52 when viewed from the Y direction. It should be noted that the intermediate recess 216 is made deeper in a portion where the starting-column irradiation trace 210 overlaps the central-column irradiation trace 215 than in the starting-column irradiation trace 210. Although when just one central-column irradiation trace 215 is provided is described in the first embodiment, the number of columns of the central-column irradiation traces 215 can be changed in accordance with the width in the X direction in the connecting part 117.

A portion which overlaps the scanning range of the central-column laser beam L2 out of the outer peripheral wrinkle 211 formed by the scanning with the starting-column laser beam L1 is removed by the irradiation with the central-column laser beam L2. On the other hand, on the periphery of a portion which is irradiated only with the central-column laser beam L2 out of the return plate 52, a wrinkle may newly be formed by the irradiation with the central-column laser beam L2 in some cases. As a result, the outer peripheral wrinkle 211 remains on the outer peripheral edge of the intermediate recess 216 so as to surround the periphery of the intermediate recess 216. Further, in a boundary portion between the central-column irradiation trace 215 and the starting-column irradiation trace 210 out of a bottom surface of the intermediate recess 216, there is formed a first internal wrinkle 220 which protrudes from the bottom surface of the intermediate recess 216.

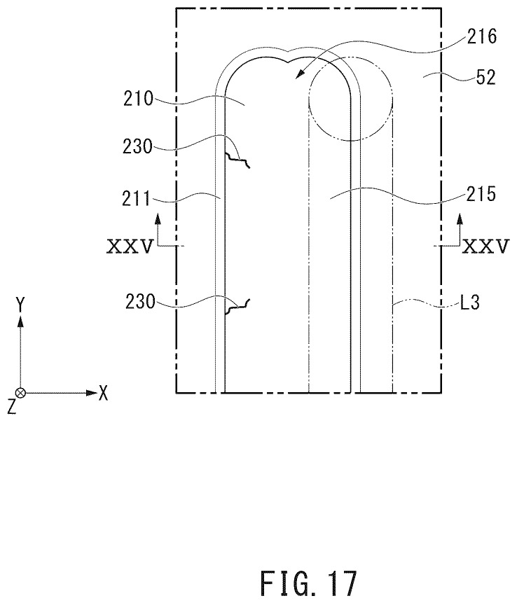

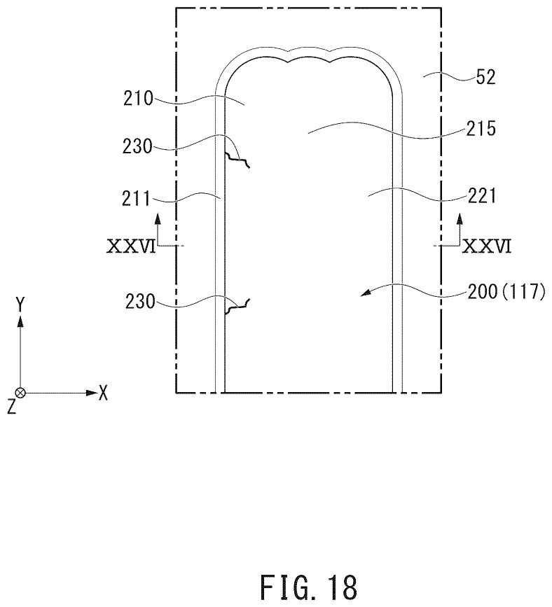

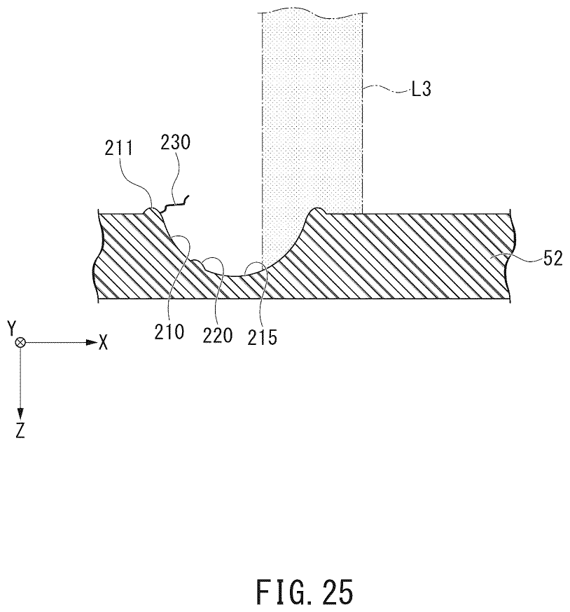

Then, as shown in FIG. 17 and FIG. 25, scanning with a third-column (the last-column) laser beam L3 is performed. In the first embodiment, an amount of the offset of the last-column laser beam L3 with respect to the central-column laser beam L2 is substantially the same as, for example, the amount of the offset of the central-column laser beam L2 with respect to the starting-column laser beam L1. Thus, a last-column irradiation trace (the first laser irradiation trace) 221 shown in FIG. 18 and FIG. 26 is formed. The last-column irradiation trace 221 is formed so as to overlap the +X-side end portion of the laser irradiation trace in the previous column (the central-column irradiation trace 215) to thereby form the outer shape part 200 together with the starting-column irradiation trace 210 and the central-column irradiation trace 215. The outer shape part 200 forms an outer shape in the plan view of the connecting part 117. As shown in FIG. 18, the last-column irradiation trace 221 extends in parallel to the central-column irradiation trace 215 in a state of being connected to the central-column irradiation trace 215 in the plan view. As shown in FIG. 26, the last-column irradiation trace 221 is recessed in a circular-arc shape with respect to the lower surface of the return plate 52 when viewed from the Y direction.

A portion which overlaps the scanning range of the last-column laser beam L3 out of the outer peripheral wrinkle 211 formed by the scanning with the starting-column laser beam L1 and the central-column laser beam L2 is removed by the irradiation with the last-column laser beam L3. On the other hand, on the periphery of a portion which is irradiated only with the last-column laser beam L3 out of the return plate 52, a wrinkle may newly be formed by the irradiation with the last-column laser beam L3 in some cases. As a result, the outer peripheral wrinkle 211 remains on the outer peripheral edge of the outer shape part 200 so as to surround the periphery of the outer shape part 200. It should be noted that in a boundary portion between the central-column irradiation trace 215 and the last-column irradiation trace 221, there is formed a second internal wrinkle 222 which protrudes from the bottom surface of the outer shape part 200.

This terminates the first laser irradiation step S411.

Incidentally, there is a possibility that a burr 230 adheres to an inner surface of the outer shape part 200 after the first laser irradiation step S411. The burr 230 is apt to adhere to the inner surface along the scanning direction out of the existing irradiation trace (e.g., the starting-column irradiation trace 210) since a portion melted by the laser beam flies in all directions when, for example, forming the central-column irradiation trace 215 and the last-column irradiation trace 221. In the illustrated example, the burr 230 protrudes from the return plate 52 through an opening part of the outer shape part 200. Specifically, when the width of the recess (e.g., the connecting part 117) to be formed by the laser processing is wider than the laser diameter of a single column, it results in that two or more columns of laser irradiation traces are formed in the width direction (the X direction) of the recess so as to partially overlap the laser irradiation traces with each other. On this occasion, an area which is not irradiated redundantly with the laser beams exists in a part (the −X-side end portion) of the starting-column irradiation trace 210. The burr 230 is apt to remain in the area which is not irradiated redundantly with the laser beams.

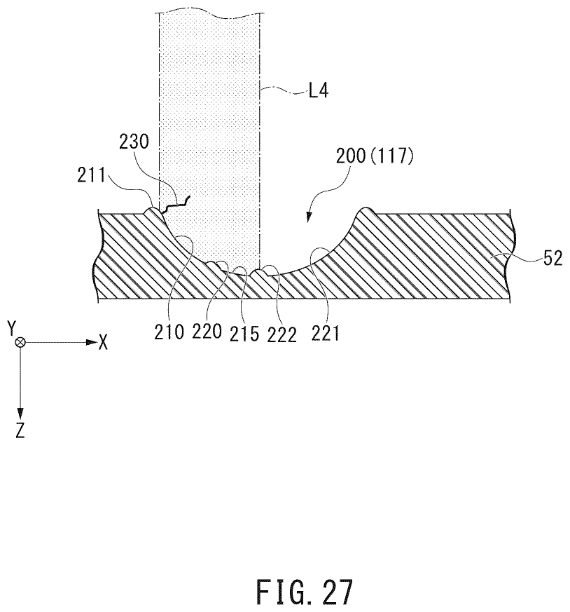

Therefore, as shown in FIG. 19 and FIG. 27, by performing the second laser irradiation step S412, the burr 230 is mainly removed. The second laser irradiation step S412 is executed by performing scanning with an additional-processing laser beam L4 along the −X-side opening edge out of the connecting part 117 (the outer shape part 200). Specifically, the additional-processing laser beam L4 is set to have substantially the same laser diameter as that of the laser beam used in the first laser irradiation step S411. However, the laser diameter may be changed between the first laser irradiation step S411 and the second laser irradiation step S412.

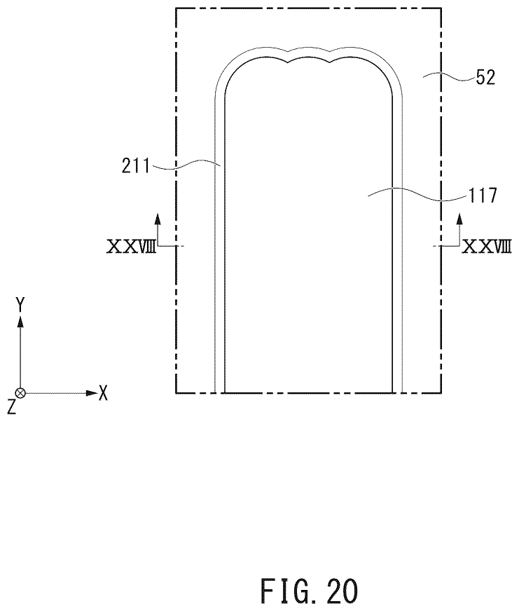

The second laser irradiation step S412 is performed at the irradiation position in the X direction in the additional-processing laser beam L4 while making the center of the laser diameter in the additional-processing laser beam L4 coincide with the center of the starting-column laser beam L1. Further, the scanning range in the Y direction in the additional-processing laser beam L4 is substantially the same as the scanning range of the laser beam in the starting column. When performing the second laser irradiation step S412 in such a condition, the irradiation with the additional-processing laser beam L4 is performed along a scan trajectory of the starting-column laser beam L1. Thus, as shown in FIG. 20 and FIG. 28, the burr 230 is removed. Further, at a place where the starting-column irradiation trace 210 is present out of the outer shape part 200, the additional-processing laser irradiation trace 201 is formed by the additional-processing laser beam L4. The additional-processing laser irradiation trace 201 forms the connecting part 117 together with the outer shape part 200. In the connecting part 117, it results in that the outer peripheral wrinkle 211 remains on the opening edge on the one hand, and an internal wrinkle 225 remains on the bottom surface on the other hand. The internal wrinkle 225 is a wrinkle which is formed in a boundary portion of the additional-processing laser irradiation trace 201 on the bottom surface of the outer shape part 200.

Subsequently, in the upstream opening forming step S42, laser processing, for example, is applied to a formation region of the upstream opening 115 in the bottom surface of the connecting part 117 so as to penetrate the return plate 52. Thus, the upstream opening 115 is formed.

Regarding the downstream opening forming step S43, laser processing, for example, is applied to a formation region of the downstream opening 116 in the bottom surface of the connecting part 117 so as to penetrate the return plate 52. Thus, the downstream opening 116 is formed. It should be noted that it may be arranged that the internal wrinkle 225 is removed when forming the upstream opening 115 and the downstream opening 116 with the laser processing.

This completes the return plate processing step S4 (the state in FIG. 12).

In the first embodiment, the return plate 52 is bonded to the chip modules 51A, 51B, and then the communication channels 110, 111 are formed, but this configuration is not a limitation. It is possible to provide the communication channels 110, 111 to the return plate 52 in advance, and then bond the return plate 52 to the chip modules 51A, 51B. Further, there is described the method of performing the first laser irradiation step S411 and the second laser irradiation step S412 in a row in the first embodiment, but this configuration is not a limitation. For example, it is possible to perform the first laser irradiation step S411, then perform the upstream opening forming step S42 and the downstream opening forming step S43, and then perform the second laser irradiation step S412 at the end of the return plate processing step S4.

In the protective film forming step S5, the protective films 125 are formed on the inner surface of the common ink chamber 80, the inner surfaces of the slits 81, the inner surfaces of the ejection channels 71, the inner surfaces of the communication channels 110, 111, the inner surfaces of the connecting channels 121, 122, and the inner surface of the manifold 123. The protective films 125 are formed by depositing a para-xylylene resin material using, for example, a chemical vapor deposition method (CVD).

In the nozzle plate stacking step S6, the nozzle plate 53 is bonded to the lower surface of the return plate 52.

Due to the steps described hereinabove, the head chip 50 is completed. It should be noted that when manufacturing the head chips 50 wafer by wafer, substantially the same step as the module forming step S1 described above is performed on an actuator plate wafer, a cover plate wafer, and a back plate wafer to thereby form a stacked body of the wafers. Subsequently, by segmentalizing the stacked body of the wafers, the plurality of chip modules 51A, 51B is taken out. Subsequently, by performing the module stacking step S2 and subsequent steps on the chip modules 51A, 51B thus taken out from the stacked body of the wafers, the head chips 50 are completed.

As described above, the head chip 50 according to the first embodiment is provided with the return plate (the flow channel member) 52 and the nozzle plate (the bonding member) 53, wherein the return plate 52 has the connecting part (the recess) 117 formed of the outer shape part 200 (the irradiation traces 210, 215, and 221), the ink is circulated through the connecting part 117, and the nozzle plate 53 is bonded to the return plate 52 so as to close the connecting part 117. In the return plate 52, the additional-processing laser irradiation trace 201 extending along the opening edge of the connecting part 117 is formed in the connecting part 117.

According to this configuration, since the additional-processing laser irradiation trace 201 is formed along the opening edge of the connecting part 117, it is possible to reduce the unwanted processing residuals (the burr 230 and so on) remaining on the opening edge of the connecting part 117 (the outer shape part 200) after the first laser irradiation step S411. Thus, it is possible to prevent the unwanted processing residuals from being jammed when bonding the return plate 52 and the nozzle plate 53 to each other. As a result, it is possible to prevent the leakage of the ink between the return plate 52 and the nozzle plate 53, and at the same time, it is possible to ensure the bonding strength between the return plate 52 and the nozzle plate 53. Further, by reducing the unwanted processing residuals in the connecting part 117, it is possible to suppress the unevenness in the connecting part 117. Thus, it is possible to reduce the circulation resistance of the ink which circulates in the connecting part 117 to thereby smoothly circulate the ink in the connecting part 117.

In the head chip 50 according to the first embodiment, the communication channels 110, 111 are each provided with the connecting part 117 which opens only on the surface facing to the −Z side (the surface facing to the bonded member side in the thickness direction) out of the return plate 52, and the upstream opening 115 and the downstream opening 116 (penetrating parts) which open on the bottom surface of the connecting part 117, and at the same time, penetrate the return plate 52 in the Z direction. The additional-processing laser irradiation trace 201 extends along at least the opening edge of the connecting part 117.

According to this configuration, there is a possibility that the unwanted processing residuals remaining on the opening edge of the connecting part 117 are exposed on a bonding surface of the return plate 52 with the nozzle plate 53. Therefore, by forming the additional-processing laser irradiation trace 201 along at least the opening edge of the connecting part 117, it is possible to prevent the unwanted processing residuals from being exposed on the bonding surface of the return plate 52 with the nozzle plate 53.

In the head chip 50 according to the first embodiment, there is adopted the configuration in which the plurality of columns of irradiation traces 210, 215, and 221 constituting the outer shape part 200 is formed in the X direction, and the additional-processing laser irradiation trace 201 extends in the Y direction along the starting-column irradiation trace (an outside laser irradiation trace) 210.

According to this configuration, the unwanted processing residuals such as the burr 230 fly in all directions due to the laser processing, and are therefore apt to adhere to the inner surfaces of the existing laser irradiation traces when performing the laser processing in the second and subsequent columns. In particular, the starting-column irradiation trace 210 forms the opening part of the connecting part 117 along the extending direction, and is therefore apt to lead to the leakage of the ink and the bonding failure described above when the unwanted processing residuals remain on the inner surfaces of the starting-column irradiation trace 210. Therefore, by forming the additional-processing laser irradiation trace 201 along the starting-column irradiation trace 210 out of the plurality of irradiation traces 210, 215, and 221, it is possible to effectively reduce the unwanted processing residuals remaining along the extending direction of the starting-column irradiation trace 210.

In the head chip 50 according to the first embodiment, there is adopted the configuration in which the connecting part 117 is formed to have a rectangular shape having the longitudinal direction set to the Y direction and the transverse direction set to the X direction when viewed from the Z direction.

According to this configuration, since the longitudinal direction of the connecting part 117 and the extending direction of the additional-processing irradiation trace 201 coincide with each other, the unwanted processing residuals can be reduced along the longitudinal direction of the connecting part 117.

In the head chip 50 according to the first embodiment, the communication channels 110, 111 each include the upstream opening (first penetrating part) 115 and the downstream opening (second penetrating part) 116 which is disposed at a distance from the upstream opening 115 in the Y direction, and is communicated with the upstream opening 115 through the connecting part 117. The chip modules (chip main bodies) 51A, 51B, which are provided with the ejection channels (pressure chambers) 71 communicated with the communication channels 110, 111 through the upstream openings 115, and the connecting channels (circulation channels) 121, 122 communicated with the communication channels 110, 111 through the downstream openings 116, are bonded to the return plate 52 at an opposite side to the nozzle plate 53, and the nozzle plate 53 is provided with the nozzle holes (jet holes) 131, 132 for ejecting the ink in the communication channels 110, 111 to the outside.

According to this configuration, the flow channel member has a function as the return plate 52 which is communicated with the nozzle holes 131, 132 and circulates the ink between the ejection channels 71 and the connecting channels 121, 122. In this case, in the head chip 50 according to the first embodiment, since it is possible to suppress the unevenness in the communication channels 110, 111, it is possible to smoothly perform the circulation of the ink between the nozzle holes 131, 132, the ejection channels 71, and the connecting channels 121, 122 through the communication channels 110, 111.

Since the inkjet head 5 and the printer 1 according to the first embodiment are each provided with the head chip 50 described above, it is possible to provide the inkjet head 5 and the printer 1 which are excellent in reliability.

### Second Embodiment

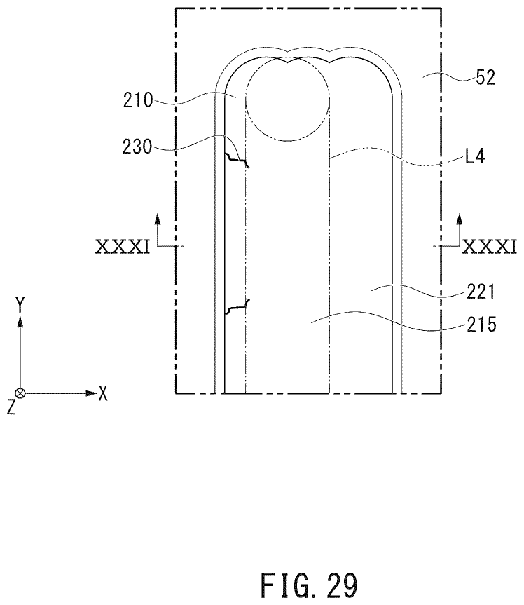

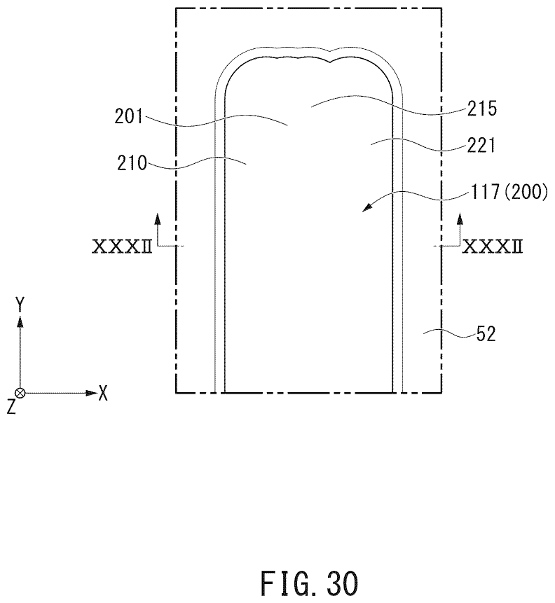

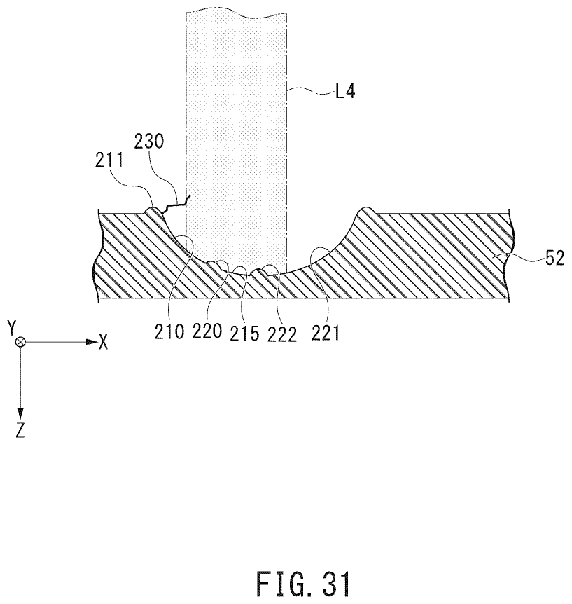

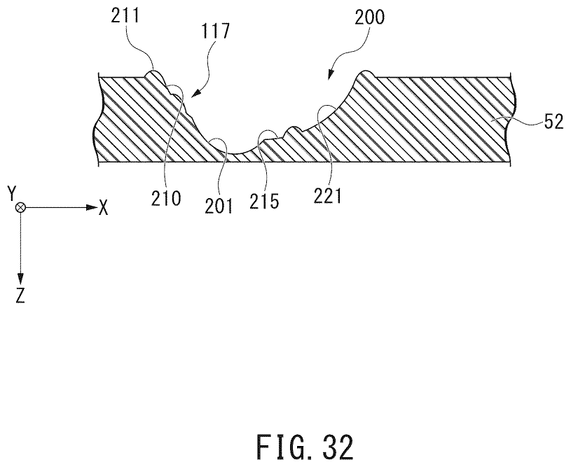

FIG. 29 to FIG. 32 are process diagrams of a second laser irradiation step S412 related to a second embodiment. Out of FIG. 29 to FIG. 32, FIG. 29 and FIG. 30 are each a bottom view of a portion corresponding to the portion A in FIG. 6. Out of FIG. 29 to FIG. 32, FIG. 31 and FIG. 32 are each a cross-sectional view of the return plate 52.

The second embodiment is different from the first embodiment described above in the point that the second laser irradiation step S412 is performed in the state in which the center of the additional-processing laser beam L4 is disposed at a position shifted in the X direction from the center of the starting-column laser beam L1. Specifically, in the second laser irradiation step S412 related to the second embodiment, irradiation with the additional-processing laser beam L4 is performed so that the additional-processing laser irradiation trace 201 is formed at the inner side (the +X side) in the X direction with respect to the opening edge of the connecting part 117 (the starting-column irradiation trace 210). In this case, it is preferable to perform the irradiation so that the center of the laser diameter in the additional-processing laser beam L4 is located between the center of the laser diameter in the starting-column laser beam L1 and the center of the laser diameter in the central-column laser beam L2. However, the center of the laser diameter in the additional-processing laser beam L4 can be changed to a position as appropriate as long as the heat of at least the additional-processing laser beam L4 propagates to the burr 230 at that position.

Then, due to the influence of the heat which propagates to the periphery of the additional-processing laser beam L4, the burr 230 is removed. Specifically, when forming the additional-processing laser irradiation trace 201, the burr 230 protruding from the opening edge of the connecting part 117 and so on can effectively be removed.

Further, the additional-processing laser irradiation trace 201 is formed so that the center in the X direction is located in a portion located between the center in the X direction in the starting-column irradiation trace 210 and the center in the X direction in the central-column irradiation trace 215. In other words, the center (the deepest portion) in the X direction in the additional-processing laser irradiation trace 201 is disposed at a position shifted from the centers (the deepest portions) in the X direction in the irradiation traces 210, 215 adjacent to each other.

In the head chip 50 according to the second embodiment, there is adopted the configuration in which the center in the X direction in the additional-processing laser irradiation trace 201 is located at the inner side in the X direction from the center in the X direction in the starting-column irradiation trace 210.

According to this configuration, by disposing the center in the X direction in the additional-processing laser irradiation trace 201 at the inner side in the X direction from the center in the X direction in the starting-column irradiation trace 210, it is possible to remove the burr 230 due to the influence of the heat propagating to the periphery of the additional-processing laser beam L4. In this case, the influence of the heat propagating to the opening edge of the outer shape part 200 (the connecting part 117) can be suppressed compared to when performing the scanning with the additional-processing laser beam L4 on the same trajectory as the scan trajectory of the starting-column laser beam L1. Thus, it is possible to prevent the outer peripheral wrinkle 211 from being enlarged by the additional-processing laser beam L4. Therefore, it is possible to prevent the outer peripheral wrinkle 211 from being jammed as the unwanted processing residuals when bonding the return plate 52 and the nozzle plate 53 to each other. As a result, it is possible to prevent the leakage of the ink between the return plate 52 and the nozzle plate 53, and at the same time, it is possible to ensure the bonding strength between the return plate 52 and the nozzle plate 53.

Moreover, since the center in the X direction is shifted between the additional-processing laser irradiation trace 201, and the starting-column irradiation trace 210 and the central-column irradiation trace 215, it is also possible to prevent the inner peripheral wrinkle from being enlarged. As a result, since the unevenness in the connecting part 117 can be suppressed, it is possible to reduce the circulation resistance of the ink which circulates in the communication channels 110, 111 to thereby smoothly circulate the ink in the communication channels 110, 111.

### Third Embodiment

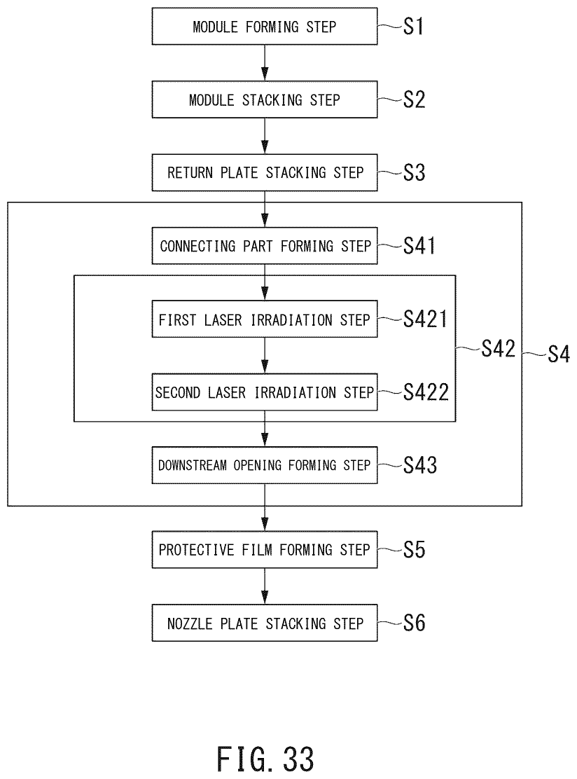

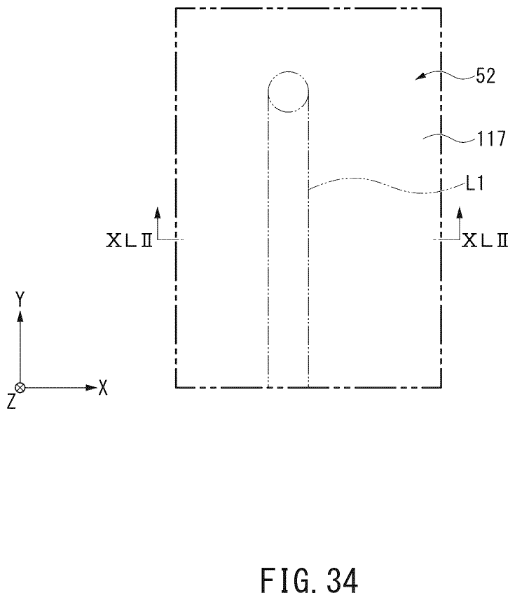

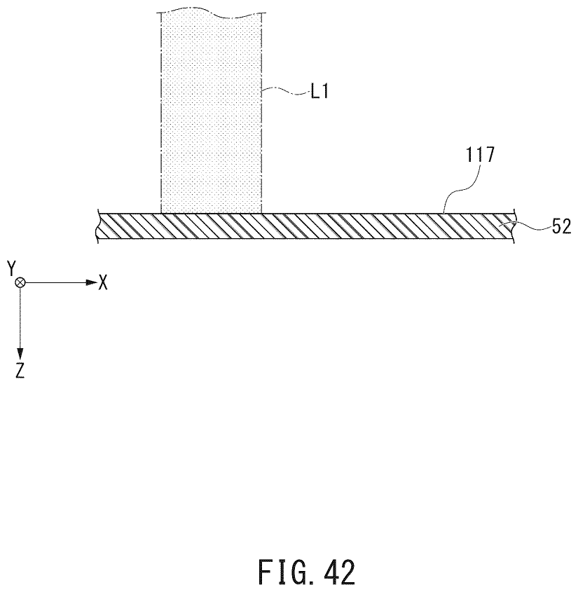

A third embodiment is different from the embodiments described above in the point that the laser irradiation for additional processing is performed with respect to the method of forming the upstream opening 115 which forms the penetrating part. FIG. 33 is a flowchart illustrating a method of manufacturing a head chip 50 according to the third embodiment. FIG. 34 to FIG. 49 are process diagrams of the upstream opening forming step S42. Out of FIG. 34 to FIG. 49, FIG. 34 to FIG. 41 are each a bottom view of a portion corresponding to the portion A in FIG. 6 of the return plate 52. Out of FIG. 34 to FIG. 49, FIG. 42 to FIG. 49 are each a cross-sectional view of the return plate 52. The correspondence relationship between FIG. 42 to FIG. 49 and FIG. 34 to FIG. 41 is as the cross-section pointing lines denoted by the roman numerals in FIG. 34 to FIG. 41, respectively.

As shown in FIG. 33, the upstream opening forming step S42 is provided with the first laser irradiation step S421 and the second laser irradiation step S422. In the following description, regarding the constituents substantially the same as those of the first embodiment, the description will be omitted as appropriate.

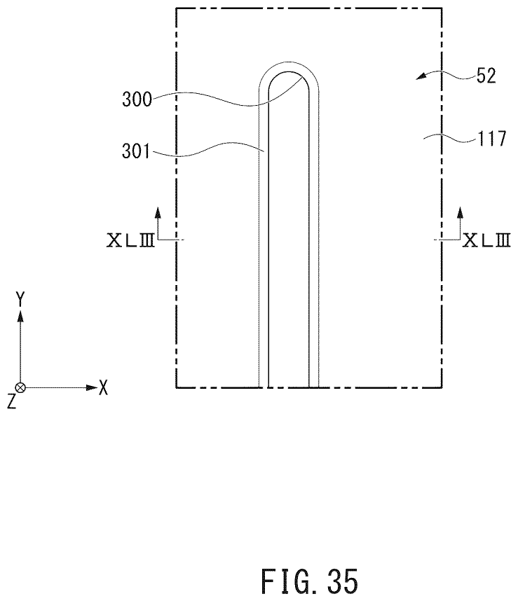

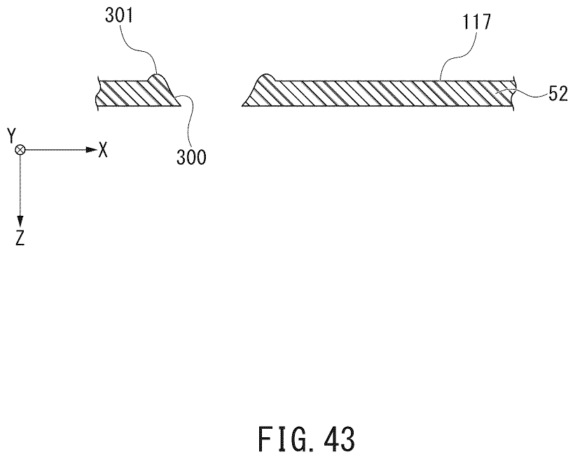

In the first laser irradiation step S421, the bottom surface of the connecting part 117 out of the return plate 52 is irradiated with the laser beam to thereby form the outer shape in the plan view of the upstream opening 115. Specifically, by setting the Y direction as a laser scanning direction, and setting the X direction as a pitch direction (a column direction), scanning with the laser beam is performed over a plurality of columns. As shown in FIG. 34 and FIG. 42, in the first laser irradiation step S421, irradiation with the starting-column laser beam L1 is performed. Specifically, by scanning a position corresponding to the −X-side end portion of the upstream opening 115 in the bottom surface of the connecting part 117 with the laser beam along the Y direction, a starting-column irradiation trace (the first laser irradiation trace) 300 shown in FIG. 35 and FIG. 43 is formed. As shown in FIG. 35, the starting-column irradiation trace 300 extends linearly along the Y direction in the plan view. As shown in FIG. 43, the starting-column irradiation trace 300 penetrates the return plate 52 via the connecting part 117. It should be noted that after forming the starting-column irradiation trace 300, an outer peripheral wrinkle 301 which protrudes from the bottom surface of the connecting part 117 is present on the opening edge of the starting-column irradiation trace 300.

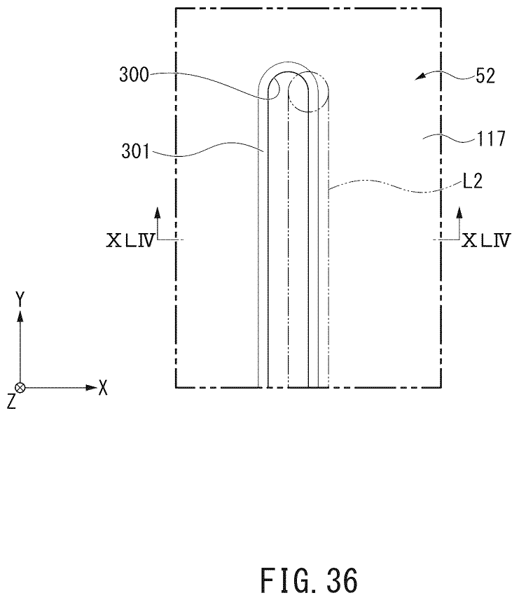

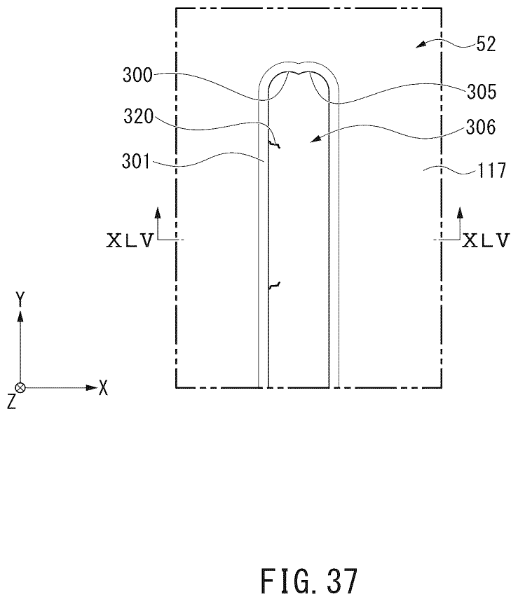

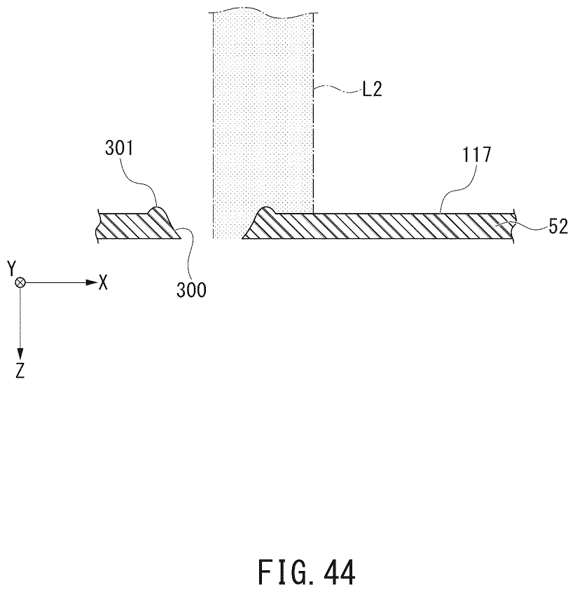

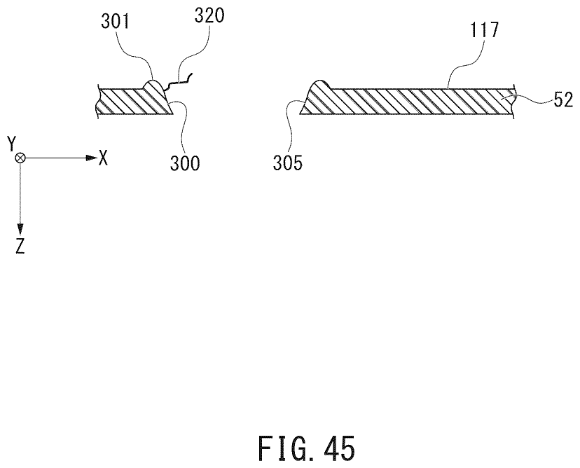

Subsequently, as shown in FIG. 36 and FIG. 44, scanning with a second-column (the central-column) laser beam L2 is performed. The scanning with the central-column laser beam L2 is performed while the center of the laser diameter is provided with an offset toward the +X side with respect to the center of the laser diameter in the previous column (the starting-column laser beam L1). Thus, a central-column irradiation trace 305 shown in FIG. 37 and FIG. 45 is formed. The central-column irradiation trace 305 is formed so as to overlap the +X-side end portion of the laser irradiation trace in the previous column (the starting-column irradiation trace 300) to thereby form an intermediate recess 306 together with the starting-column irradiation trace 300. As shown in FIG. 37, the central-column irradiation trace 305 extends in parallel to the starting-column irradiation trace 300 in a state of being connected to the starting-column irradiation trace 300 in the plan view. As shown in FIG. 45, the central-column irradiation trace 305 penetrates the return plate 52 together with the starting-column irradiation trace 300. It should be noted that although when just one central-column irradiation trace 305 is provided is described in the third embodiment, the number of columns of the central-column irradiation traces 305 can be changed in accordance with the width in the X direction in the upstream opening 115.

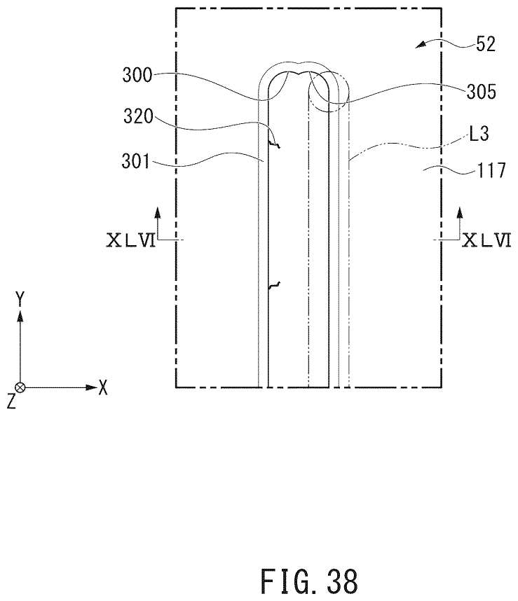

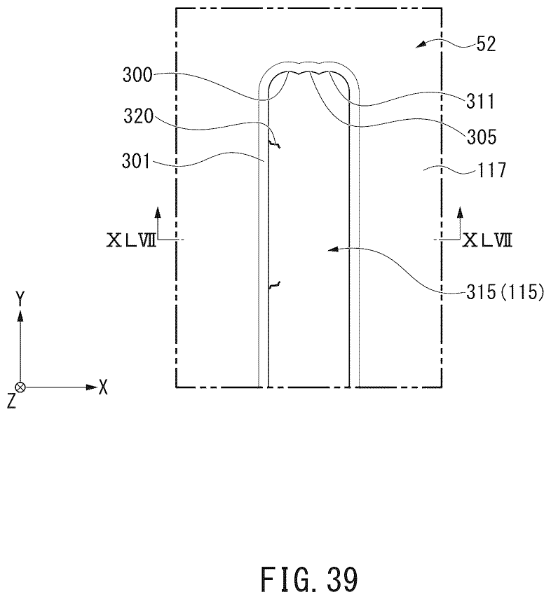

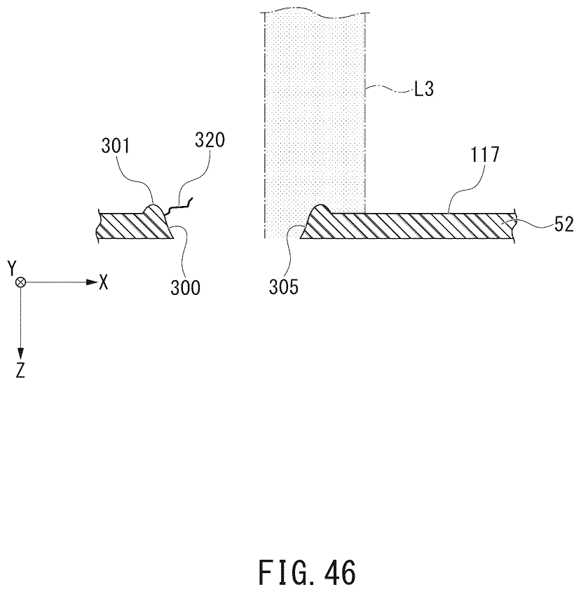

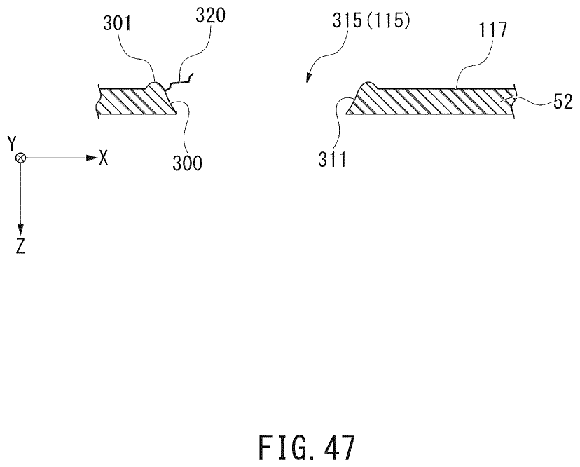

Then, as shown in FIG. 38 and FIG. 46, scanning with the last-column (a third-column) laser beam L3 is performed. In the third embodiment, an amount of the offset of the last-column laser beam L3 is substantially the same as, for example, the amount of the offset of the central-column laser beam L2 with respect to the starting-column laser beam L1. Thus, a last-column irradiation trace 311 shown in FIG. 39 and FIG. 47 is formed. The last-column irradiation trace 311 is formed so as to overlap the +X-side end portion of the laser irradiation trace in the previous column (the central-column irradiation trace 305) to thereby penetrate the return plate 52 together with the starting-column irradiation trace 300 and the central-column irradiation trace 305. The last-column irradiation trace 311 extends in parallel to the central-column irradiation trace 305 in a state of being connected to the central-column irradiation trace 305.

This terminates the first laser irradiation step S421. In other words, in the first laser irradiation step S421, an outer shape part 315 having an outer shape in the plan view equivalent to that of the upstream opening 115 is formed.

After the first laser irradiation step S421, there is a possibility that the portion melted by, for example, the central-column laser beam L2 in the formation of, for example, the central-column irradiation trace 305 adheres to the inner surface of the starting-column irradiation trace 300 as a burr 320 in the inner surface of the outer shape part 315 (the upstream opening 115).

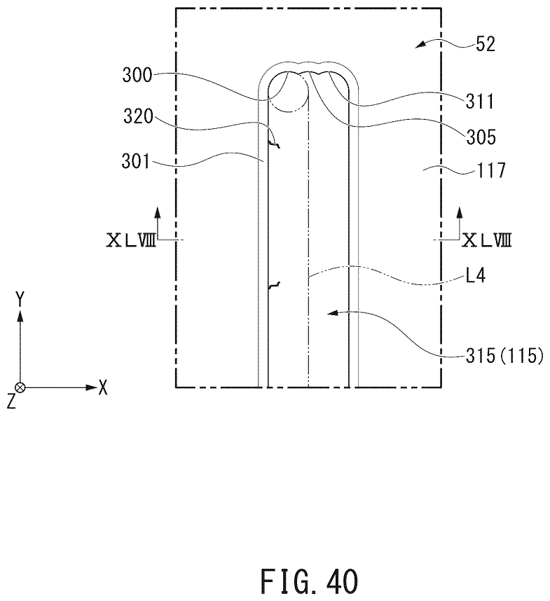

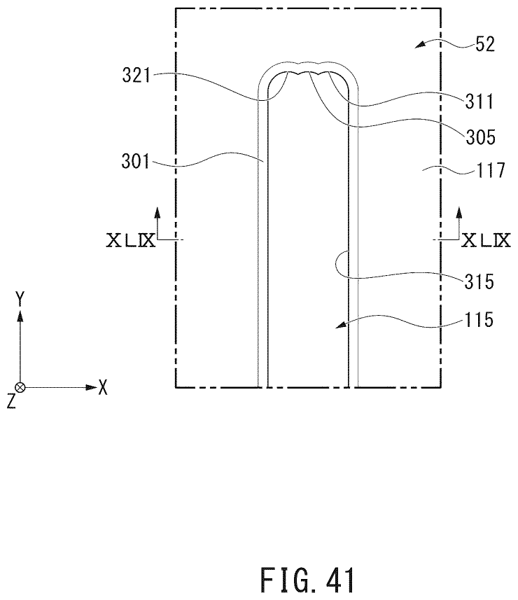

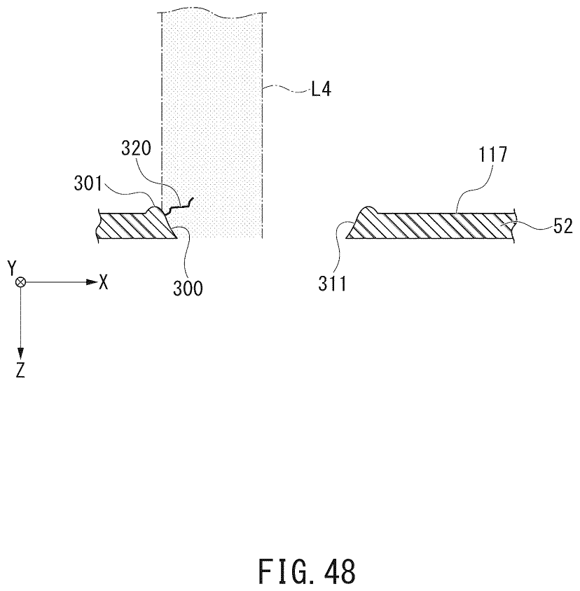

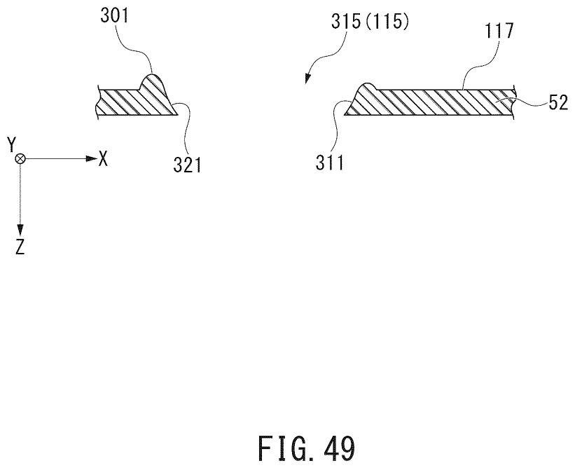

Therefore, as shown in FIG. 40 and FIG. 48, by performing the second laser irradiation step S422, the burr 320 is mainly removed. The second laser irradiation step S422 is executed by performing irradiation with the additional-processing laser beam L4 along the −X-side opening edge out of the outer shape part 315 (the upstream opening 115). Specifically, the center of the laser diameter in the additional-processing laser beam L4 coincides with the center of the starting-column laser beam L1. Meanwhile, the scanning range in the Y direction in the additional-processing laser beam L4 is substantially the same as the scanning range of the starting-column laser beam L1. When performing the second laser irradiation step S422 in such a condition, the irradiation with the additional-processing laser beam is performed along the scan trajectory of the starting-column laser beam L1. Thus, as shown in FIG. 41 and FIG. 49, the burr 320 is removed. Further, at a place where the starting-column irradiation trace 300 is present out of the outer shape part 315, an additional-processing laser irradiation trace (the second laser irradiation trace) 321 is formed by the additional-processing laser beam L4. The additional-processing laser irradiation trace 321 forms the upstream opening 115 together with the laser irradiation traces 300, 305, and 311.

In the second embodiment, by executing the first laser irradiation step S421 and the second laser irradiation step S422 on the upstream opening 115 as the penetrating part, substantially the same functions and advantages as those of the first embodiment described above are exerted.

Further, by removing the burr 320 in advance before bonding the return plate 52 and the nozzle plate 53 to each other, it is possible to prevent the burr 320 from dropping and then being retained in the ink after bonding the return plate 52 and the nozzle plate 53 to each other. It should be noted that in the third embodiment, there is described when the method of manufacturing the head chip 50 according to the present disclosure is adopted in the upstream opening 115, but it is also possible to apply the method of manufacturing the head chip 50 according to the present disclosure to the processing of the downstream opening 116.

### Fourth Embodiment

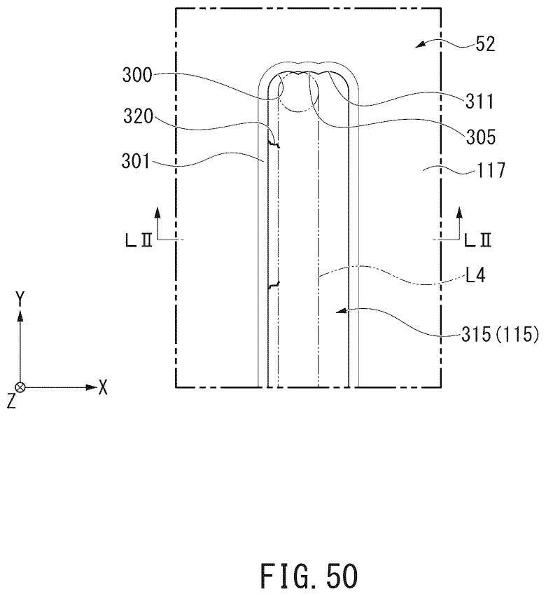

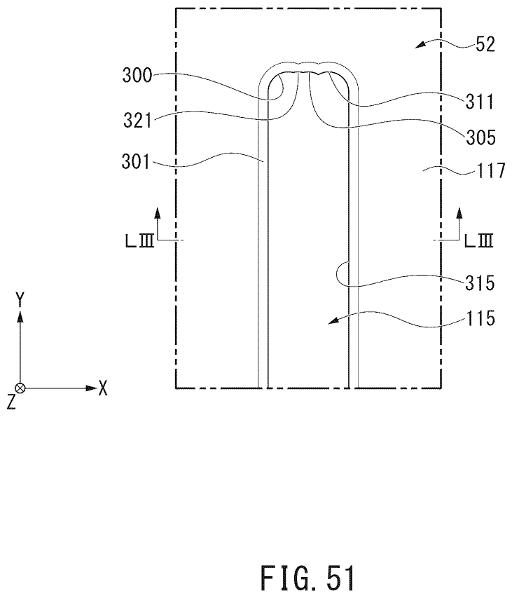

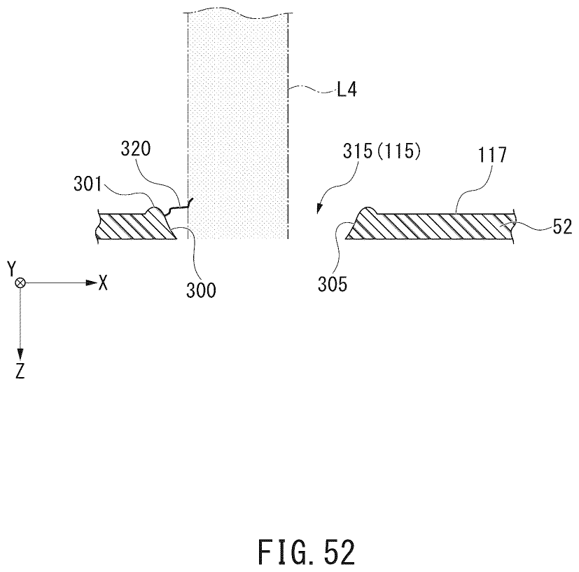

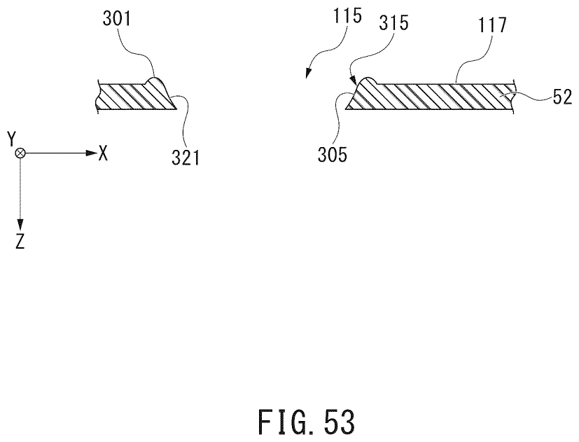

FIG. 50 to FIG. 53 are process diagrams of a second laser irradiation step S422 related to a fourth embodiment. Out of FIG. 50 to FIG. 53, FIG. 50 and FIG. 51 are each a bottom view of a portion corresponding to the portion A in FIG. 6. Out of FIG. 50 to FIG. 53, FIG. 52 and FIG. 53 are each a cross-sectional view of the return plate 52.

The fourth embodiment is different from the third embodiment described above in the point that the second laser irradiation step S422 is performed in the state in which the center of the additional-processing laser beam L4 is disposed at a position shifted in the X direction from the center of the starting-column laser beam L1. Specifically, in the second laser irradiation step S422 related to the fourth embodiment, irradiation with the additional-processing laser beam L4 is performed on the portion located at an inner side in the X direction with respect to the opening edge of the upstream opening 115. In this case, it is preferable to perform the irradiation with the additional-processing laser beam L4 so that the center of the laser diameter is located between the center of the laser diameter in the starting-column laser beam L1 and the center of the laser diameter in the central-column laser beam L2. However, the center of the laser diameter in the additional-processing laser beam L4 can be changed to a position as appropriate as long as the heat of at least the additional-processing laser beam L4 propagates to the burr 320 at that position.

Then, due to the influence of the heat which propagates to the periphery of the additional-processing laser beam L4, the burr 320 is removed. Specifically, the burr 320 protruding from the opening edge of the upstream opening 115 and so on can effectively be removed by the additional-processing laser beam L4. Further, in the fourth embodiment, the additional-processing laser irradiation trace 321, which is formed due to the influence of the heat of the additional-processing laser beam L4, remains in a portion located between the starting-column irradiation trace 300 and the central-column irradiation trace 305 on a surface facing to the +X side and a surface facing to the inner side in the Y direction out of the inner surfaces of the upstream opening 115.

Also in the fourth embodiment, similarly to the second embodiment described above, it is possible to prevent the outer peripheral wrinkle 301 remaining on the opening edge of the upstream opening 115 from being enlarged by the additional-processing laser irradiation trace 321. Therefore, it is possible to suppress the unevenness in the communication channels 110, 111. Thus, it is possible to reduce the circulation resistance of the ink which circulates in the communication channels 110, 111 to thereby smoothly circulate the ink in the communication channels 110, 111.

### Other Modified Examples

It should be noted that the scope of the present disclosure is not limited to the embodiments described above, but a variety of modifications can be applied within the scope or the spirit of the present disclosure.

For example, in the embodiments described above, the description is presented citing the inkjet printer 1 as an example of the liquid jet recording apparatus, but the liquid jet recording apparatus is not limited to the printer. For example, a facsimile machine, an on-demand printing machine, and so on can also be adopted.

In the embodiments described above, the description is presented citing the configuration (a so-called shuttle machine) in which the inkjet heads move with respect to the recording target medium when performing printing as an example, but this configuration is not a limitation. The configuration related to the present disclosure can be adopted as the configuration (a so-called stationary head machine) in which the recording target medium is moved with respect to the inkjet heads in the state in which the inkjet heads are fixed.

In the embodiments described above, there is explained when the recording target medium P is paper, but this configuration is not a limitation. The recording target medium P is not limited to paper, but can also be a metal material or a resin material, and can also be food or the like.

In the embodiments described above, there is explained the configuration in which the liquid jet heads are installed in the liquid jet recording apparatus, but this configuration is not a limitation. Specifically, the liquid to be jetted from the liquid jet heads is not limited to what is landed on the recording target medium, but can also be, for example, a medical solution to be blended during a dispensing process, a food additive such as seasoning or a spice to be added to food, or fragrance to be sprayed in the air.

In the embodiments described above, there is explained the configuration in which the Z direction coincides with the gravitational direction, but this configuration is not a limitation, and it is also possible to set the Z direction to a direction along the horizontal direction.

In the embodiments described above, there is explained the configuration (so-called pulling-shoot) of deforming the actuator plate in the direction of increasing the volume of the ejection channel due to the application of the voltage, and then restoring the actuator plate to thereby eject the ink, but this configuration is not a limitation. It is possible for the head chip according to the present disclosure to be provided with a configuration (so-called pushing-shoot) in which the ink is ejected by deforming the actuator plate in a direction of reducing the volume of the ejection channel due to the application of the voltage. When performing the pushing-shoot, the actuator plate deforms so as to bulge toward the inside of the ejection channel due to the application of the drive voltage. Thus, the volume in the ejection channel decreases to increase the pressure in the ejection channel, and thus, the ink located in the ejection channel is ejected outside through the nozzle hole. When setting the drive voltage to zero, the actuator plate is restored. As a result, the volume in the ejection channel is restored.

In the embodiment described above, there is explained the configuration in which the chip modules 51A, 51B are overlapped with each other, but this configuration is not a limitation. It is possible to configure the head chip 50 only with the first chip module 51A.

In the embodiments described above, the description is presented citing the head chip of the edge-shoot type as an example, but this configuration is not a limitation. For example, it is also possible to apply the present disclosure to the head chip 50 of a so-called side-shoot type for ejecting the ink from a central portion in the extending direction in the ejection channel 71. Further, the head chip may be of a so-called roof-shoot type in which a direction of the pressure applied to the ink and the ejection direction of the ink are made the same as each other. In the case of the roof-shoot type, a portion which faces the pressure chamber retaining the ink, and which deforms for expanding or contracting the pressure chamber, functions as a drive unit.

The configuration in which the scanning direction with the laser beam in the first laser irradiation step and the scanning direction with the laser beam in the second laser irradiation step coincide with each other is explained in the embodiments described above, but this configuration is not a limitation. The scanning direction with the laser beam in the first laser irradiation step and the scanning direction with the laser beam in the second laser irradiation step may cross each other.

In the embodiments described above, there is described when the laser irradiation in the additional processing is only performed along the opening edge formed of the starting-column irradiation trace, but this configuration is not a limitation. The laser irradiation in the additional processing may be performed over the entire circumference of the opening edge of the first laser irradiation trace.

In the embodiments described above, there is described when only the connecting part 117 is formed adopting the method of manufacturing the head chip 50 according to the present disclosure in the first embodiment, and only the upstream opening 115 (or the downstream opening 116) is formed adopting the method of manufacturing the head chip 50 according to the present disclosure in the third embodiment, but this configuration is not a limitation. The method of manufacturing the head chip 50 according to the present disclosure may be adopted with respect to both the connecting part 117 and the variety of openings 115, 116.

In the embodiments described above, there is described the configuration in which the recess related to the present disclosure is provided with the connecting part 117 as the non-penetrating part, and the openings 115, 116 as the penetrating parts, but this configuration is not a limitation. The recess may be formed only of the non-penetrating part, or may also be formed only of the penetrating part.

In the embodiments described above, the return plate 52 is described as the flow channel member, and the nozzle plate 53 is described as the bonded member, but this configuration is not a limitation. The head chip according to the present disclosure can be applied to a variety of members which configures the head chip in which a member provided with a recess as a flow channel is defined as the flow channel member, and a member to be bonded to the flow channel member is defined as the bonded member.

Besides the above, it is arbitrarily possible to replace the constituents in the embodiments described above with known constituents within the scope or the spirit of the present disclosure, and it is also possible to arbitrarily combine the modified examples described above with each other.

What is claimed is:

1. A head chip comprising:
a flow channel member which includes a recess formed of a first laser irradiation trace, and in which a liquid circulates in the recess; and
a bonded member which is bonded to the flow channel member so as to close the recess, wherein
the flow channel member is provided with a second laser irradiation trace extending along an opening edge of the recess.

2. The head chip according to claim 1, wherein the recess includes
a non-penetrating part configured to open only on a surface of the flow channel member, the surface facing to the bonded member side in a thickness direction, and
a penetrating part which is configured to open on a bottom surface of the non-penetrating part, and penetrates the flow channel member in the thickness direction, and
the second laser irradiation trace extends along at least an opening edge of the non-penetrating part.

3. The head chip according to claim 1, wherein
the first laser irradiation trace extends in a first direction crossing a thickness direction of the flow channel member, and a plurality of first laser irradiation traces each identical to the first laser irradiation trace is formed in a second direction crossing the first direction when viewed from the thickness direction, and
the second laser irradiation trace extends in the first direction along an outer side laser irradiation trace which is located at an outermost side in the second direction in the plurality of first laser irradiation traces.

4. The head chip according to claim 3, wherein
a center in the second direction in the second laser irradiation trace is located at an inner side in the second direction from a center in the second direction in the outer side laser irradiation trace.

5. The head chip according to claim 3, wherein
the recess is formed to have a rectangular shape having a longitudinal direction set to the first direction and a transverse direction set to the second direction when viewed from the thickness direction.

6. The head chip according to claim 3, wherein the recess includes
a non-penetrating part configured to open only on a surface of the flow channel member, the surface facing to the bonded member side in a thickness direction, and
a penetrating part which is configured to open on a bottom surface of the non-penetrating part, and penetrates the flow channel member in the thickness direction, and
the penetrating part includes
a first penetrating part, and
a second penetrating part which is disposed at a distance in the first direction with respect to the first penetrating part, and is communicated with the first penetrating part through the non-penetrating part,
a chip main body provided with a pressure chamber communicated with the recess through the first penetrating part and a circulation channel communicated with the recess through the second penetrating part is bonded to the flow channel member at an opposite side to the bonded member in the thickness direction, and
the bonded member is provided with a jet hole configured to jet a liquid in the recess to an outside.

7. A liquid jet head comprising the head chip according to claim 1.

8. A liquid jet recording apparatus comprising the liquid jet head according to claim 7.

9. A method of manufacturing a head chip including
a flow channel member provided with a recess through which a liquid circulates, and
a bonded member which is bonded to the flow channel member so as to close the recess, the method comprising:
a first laser irradiation step of irradiating a bonding surface of the flow channel member to the bonded member with a first laser beam to thereby form an outer shape of the recess with a first laser irradiation trace; and
a second laser irradiation step of irradiating the bonding surface with a second laser beam along an opening edge of the recess to thereby form a second laser irradiation trace along the opening edge of the recess.
